(19) United States
(12) Patent Application Publication
(10) Pub. No.: US 2025/0054503 A1
(43) Pub. Date: Feb. 13, 2025

(54) IVAS SPAR FILTER BANK IN QMF DOMAIN

(71) Applicant: DOLBY INTERNATIONAL AB, Dublin (IE)

(72) Inventors: Harald MUNDT, Fürth (DE); Lars VILLEMOES, Järfälla (SE)

(73) Assignee: DOLBY INTERNATIONAL AB, Dublin (IE)

(21) Appl. No.: 18/719,408

(22) PCT Filed: Dec. 20, 2022
(86) PCT No.: PCT/EP2022/086987

§ 371 Date: Jun. 13, 2024

Related U.S. Application Data
(60) Provisional application No. 63/291,817, filed on Dec. 20, 2021.

(51) Int. Cl. G10L 19/008; G10L 19/02

(52) U.S. Cl. CPC G10L 19/008; G10L 19/0204

(57) ABSTRACT

A method of processing a representation of a multichannel audio signal is provided. The representation includes a first channel and metadata relating to a second channel. The metadata includes, for each of a plurality of first bands of a first filter bank, a respective prediction parameter. The method includes: applying a second filterbank with a plurality of second bands to the first channel to obtain, for each second band, a banded version of the first channel; for each second band, generating a respective time-domain filter based on the prediction parameters and first filters corresponding to the first bands; and for each second band, generating a prediction for the second channel based on a filtered version of the first channel, the filtered version being obtained by applying the respective time-domain filter in that second band to the banded version of the first channel. Also provided are corresponding apparatus, programs, and computer-readable storage media.

### CROSS-REFERENCE TO RELATED APPLICATIONS

This application is a U.S. 371 national stage application of International Application No. PCT/EP2022/086987, filed on Dec. 20, 2022, which claims the priority benefit of U.S. Provisional Application No. 63/291,817, filed on Dec. 20, 2021, each of which are hereby incorporated by reference.

### TECHNICAL FIELD

The present disclosure relates to techniques for processing representations of multichannel audio signals. In particular, the present disclosure describes SPAR decoding with running the SPAR filter bank in the domain of a QMF bank (e.g., oversampled QMF bank) well suited for signal manipulation.

### BACKGROUND

IVAS SPAR is a low delay codec for First Order Ambisonics (FOA) and Higher Order Ambisonics (HOA) spatial audio based on a low latency core codec. Immersive Audio and Video Services (IVAS) Spatial Reconstruction (SPAR) uses the Modified Discrete Fourier Transform (MDFT) for signal analysis and as fast convolution kernel for the SPAR finite impulse response (FIR) filter bank. The SPAR filter bank consists of carefully designed low delay FIR band filters (typically 12) with time and frequency resolution adapted to the human auditory system. The SPAR filter bank runs at the encoder and at the decoder. At the encoder, active downmix signals and residual signals are computed and sent alongside parameters (e.g., SPAR parameters) to the decoder. At the decoder, the encoder-side processing is reversed, and the original signals are reconstructed using the transmitted parameters. For faithful reconstruction of the signals, the filter bank at the encoder and decoder should match exactly.

On the other hand, use of oversampled QMF banks at the decoder may be better suited for signal manipulation than the SPAR MDFT domain (such as parametric audio processing and decoding, for example) potentially at a fine time grid.

Thus, there is a need for techniques for enabling efficient use of decoder filter banks in the QMF domain for SPAR decoded content. There is general need for techniques for enabling use of filters of a first filter bank in the domain of a second filter bank.

### SUMMARY

In view of this need, the present disclosure provides methods and apparatus for processing representations of multichannel audio signals, as well as corresponding programs and computer-readable storage media, having the features of the respective independent claims.

An aspect of the present disclosure relates to a method of processing a representation of a multichannel audio signal. The method may be computer-implemented, for example. Processing may relate to decoding, such as SPAR decoding, for example. The multichannel audio signal may be a spatial audio signal, such as a FOA audio signal or a HOA audio signal, for example. The representation may include a first channel and metadata relating to a second channel. Further, the representation of the multichannel audio signal may include more than one second channel. The first channel may be a transport channel (or a channel encoded to a transport channel) and the second channels may be channels other than the transport channel (or the channel encoded to the transport channel), in particular, channels that are parametrically coded. The metadata may include, for each of a plurality of first bands of a first filter bank, a respective prediction parameter (e.g., a gain parameter) for making a prediction for the second channel based on the first channel in that first band. The method may include applying a second filterbank with a plurality of second bands to the first channel to obtain, for each of the second bands, a banded version of the first channel in that second band. The second filter bank may be different from the first filter bank. The method may further include, for each of the second bands, generating a respective time-domain filter based on the prediction parameters and first filters of the first filter bank. Therein, the first filters may correspond to the first bands. The method may yet further include generating a prediction for the second channel based on the banded versions of the first channel and the time-domain filters in the second bands. This may involve, for example, for each of the second bands generating a prediction for the second channel in that second band based on a filtered version of the first channel in that second band. Therein, the filtered version of the first channel may be obtained by applying the respective time-domain filter in that second band to the banded version of the first channel in that second band.

Accordingly, reconstruction of the original multichannel audio signal and subsequent audio processing does not require transformation to the domain of the first filter bank followed by transformation to the domain of the second filter bank. Instead, the filters of the first filter bank may be “emulated” in the domain of the second filter bank, thereby avoiding additional conversion steps. This allows to profit from specific advantages of the first filter bank for encoding (such as bands specifically adapted to human hearing, etc.), while also profiting from specific advantages of the second filter bank for additional signal processing of the reconstructed multichannel audio signal (such as better time resolution, etc.), without additional computational burden.

In some embodiments, the multichannel audio signal may be a First Order Ambisonics, FOA, or Higher Order Ambisonics, HOA, audio signal.

In some embodiments, the prediction parameters may be SPAR parameters (e.g., gain parameters).

In some embodiments, the first filter bank may be a SPAR filter bank comprising FIR band filters and may use an MDFT. For SPAR, there may be 12 first bands, for example.

In some embodiments, the second filter bank may be a QMF filter bank. Further, the second filter bank may be an oversampled filter bank, in particular an oversampled QMF filter bank, for example.

In some embodiments, the time-domain filters may be multi-tap FIR filters. In some embodiments, generating the time-domain filter for a given second band may include generating a plurality of adapted first filters based on respective first filters and a prototype filter for filter conversion.

In some embodiments, for a given second band l the adapted first filter Hₗ^{b} of a first filter h_{b} for a given first band b may be calculated as

$${H}_{l}^{b} = {\sum }_{n} {h}_{b} ( n + kS ) q ( n ) exp ( - i \frac{π}{L} ( l + \frac{1}{2} ) n )$$

where q is the prototype filter for filter conversion, S is the stride of the second filterbank, L is the number of second bands, and summation for n is over the support of the prototype filter q for filter conversion.

In some embodiments, the method may further include generating the prototype filter for filter conversion based on a prototype filter of the second filterbank. In some embodiments, the prototype filter for filter conversion may be generated based on the prototype filter of the second filterbank by solving a least-squares problem.

In some embodiments, generating the prototype filter for filter conversion may include generating an acausal prototype filter p_{A} based on the prototype filter p of the second filterbank. Said generating may further include generating a cross-correlation p₂ of the acausal prototype filter p_{A} and the prototype filter p of the second filterbank. Said generating may further include generating a set of matrices V^{(k)}, k=−K, . . . , K for some integer K with dimensions S×R and with non-zero elements v_{n,m} only for indices n, m with n-m being an integer multiple of S, where R is the length of the prototype filter for filter conversion. Said generating may yet further include solving a set of least-square problems for V^{(k)} q, where q is a vector of dimensions R×1 including the filter coefficients of the prototype filter q for filter conversion.

In some embodiments, generating the time-domain filter for a given second band may further include taking a weighted sum of the adapted first filters. Therein, the adapted first filters may be weighted with the prediction coefficients (e.g., gains) for the respective first bands.

In some embodiments, the prototype filter for filter conversion may be an asymmetric prototype filter.

In some embodiments, the processing stride for each tap may be equal to or smaller than the number of second bands.

In some embodiments, generating the time-domain filter for a given second band may include approximating a given first filter by first and second elementary signals. Therein, the first elementary signals may be obtainable as results of applying the second filter bank, elementary real-valued single-tap filters, and a synthesis filter bank of the second filter bank to elementary signals with single non-zero samples at respective sample positions. The elementary real-valued single-tap filters may be filters for respective single ones of the second bands with single non-zero filter coefficients at respective tap positions. Further, the second elementary signals may be obtainable as results of applying the second filter bank, elementary imaginary single-tap filters, and the synthesis filter bank of the second filter bank to the elementary signals, wherein the elementary imaginary single-tap filters are filters for respective single ones of the second bands with single non-zero filter coefficients at respective tap positions. Said generating may further include generating adapted time domain filters for the first filters in the second band based on coefficients of first and second elementary signals in the approximation.

In some embodiments, generating the time-domain filter for a given second band may include obtaining results u_{p,l,k} of applying the second filterbank, real-valued single tap filters Fλ^{(re)}(κ)=δ(λ−l, κ−k), and a synthesis filterbank of the second filterbank to signals xₚ(k)=δ(k−p), where l indicates a given second band, p indicates a given sample position, and k indicates a filter tap position. Said generating may further include obtaining results v_{p,l,k} of applying the second filterbank, imaginary single tap filters F_{λ}^{(im)}(κ)=iδ(λ−l, κ−k), and the synthesis filterbank of the second filterbank to the signals xₚ(k)=δ(k−p). Said generating may further include determining a least-squares solution for coefficients aₗ and bₗ such that

$${\sum }_{l = 0}^{L - 1} {\sum }_{k = 0}^{{N}_{l}} ( {a}_{l} ( k ) {u}_{p , l , k} ( n ) + {b}_{l} ( k ) {v}_{p , l , k} ( n ) ) \approx {h}_{b} ( n - {D}_{3} - p )$$

for a given delay D₃, where h_{b} is the first filter for first band b, L is the number of second bands, and Nₗ is a predefined number of filter taps for second band l. Said generating may yet further include generating an adapted first filter He of the first filter h_{b} in the second band l as Hₗ^{b}=aₗ+ibₗ.

In some embodiments, the method may further include truncating a filter length of the time-domain filters.

Thereby, computational complexity can be reduced, potentially without perceivable effect.

In some embodiments, the filter length of a given time-domain filter after truncation may depend on the respective second band of the time domain filter.

In some embodiments, generating the time-domain filter for a given second band may involve generating a respective elementary (or adapted) time-domain filter (e.g., adapted filter) in the given second band for each of the first filters, and generating the time-domain filter in the given second band based on the elementary time-domain filters in the given second band and the prediction parameters. Then, truncation of a time-domain filter for the given second band may be based on threshold values for the filter coefficients of the elementary time-domain filters, with each threshold value corresponding to a respective one among the first filters. The threshold value for the elementary time-domain filters for a given first filter may be derived from a maximum magnitude of said elementary time-domain filters in the plurality of second bands.

In some embodiments, the method may further include determining, for each first band, a maximum magnitude of the corresponding elementary time-domain filters in the plurality of second bands. The method may further include, for each first band, determining a minimum truncated filter length for the corresponding elementary time-domain filters in the plurality of second bands based on a threshold value derived from said maximum magnitude. The method may yet further include, for each second band, determining the filter length of the time-domain filter in that second band based on the minimum truncated filter lengths of the elementary time-domain filters in that second band.

In some embodiments, the time-domain filters may be single-tap FIR filters. By resorting to single-tap FIR filters, the filters of the first filter bank can be emulated in the domain of the second filter bank with minimum computational burden.

In some embodiments, generating the time-domain filter for a given second band may include determining a first band among the plurality of first bands that has a highest energy in that second band. Said generating may further include generating the time-domain filter based on a linear-phase approximation of the first filter corresponding to the determined first band and the corresponding prediction coefficient for the determined first band.

In some embodiments, generating the time-domain filter for a given second band may include determining a set of first bands among the plurality of first bands that have a highest energy in that second band. Said generating may further include generating the time-domain filter based on a weighted sum of linear-phase approximations of the first filters corresponding to the determined set of first bands. Therein, weights in the weighted sum may depend on the corresponding prediction coefficients for the determined set of first bands and respective normalized magnitudes or energies of the first bands of the determined set of first bands in that second band. Here, it is understood that the normalized magnitudes or energies sum to unity.

According to another aspect, a method of generating a representation of a multichannel audio signal is provided. The representation may include a first channel and metadata relating to a second channel. The metadata may include, for each of a plurality of first bands of a first filter bank, a respective prediction parameter for making a prediction for the second channel based on the first channel in that first band. The method may include generating a prediction for the second channel based on first filters of the first filter bank and the prediction parameters. Therein, the prediction for the second channel may be represented by a time-domain signal (e.g., prediction signal). The method may further include generating a residual of the second channel by subtracting the prediction of the second channel from the second channel in the time-domain.

In some embodiments, the representation of the multichannel audio signal may further include the residual of the second channel.

According to another aspect, an apparatus for processing representations of multichannel audio signals is provided. The apparatus may include a processor and a memory coupled to the processor and storing instructions for the processor. The processor may be configured to perform all steps of the methods according to preceding aspects and their embodiments.

According to a another aspect, a computer program is described. The computer program may comprise executable instructions for performing the methods or method steps outlined throughout the present disclosure when executed by a computing device. According to yet another aspect, a computer-readable storage medium is described. The storage medium may store a computer program adapted for execution on a processor and for performing the methods or method steps outlined throughout the present disclosure when carried out on the processor.

It should be noted that the methods and systems including its preferred embodiments as outlined in the present disclosure may be used stand-alone or in combination with the other methods and systems disclosed in this document. Furthermore, all aspects of the methods and systems outlined in the present disclosure may be arbitrarily combined. In particular, the features of the claims may be combined with one another in an arbitrary manner.

It will be appreciated that apparatus features and method steps may be interchanged in many ways. In particular, the details of the disclosed method(s) can be realized by the corresponding apparatus, and vice versa, as the skilled person will appreciate. Moreover, any of the above statements made with respect to the method(s) (and, e.g., their steps) are understood to likewise apply to the corresponding apparatus (and, e.g., their blocks, stages, units), and vice versa.

### BRIEF DESCRIPTION OF THE DRAWINGS

The invention is explained below in an exemplary manner with reference to the accompanying drawings, wherein

FIG. 1 is a block diagram schematically illustrating an example of SPAR encoding and SPAR decoding followed by processing in the QMF filter band domain;

FIG. 2 is a block diagram schematically illustrating an example of SPAR encoding and SPAR decoding in the QMF filter bank domain according to embodiments of the disclosure;

FIG. 3 is a flowchart schematically illustrating an example of a method of processing a representation of a multichannel audio signal according to embodiments of the disclosure;

FIG. 4 schematically illustrates an example of conversion of SPAR filter bank FIR band filters to QMF domain FIR filters according to embodiments of the disclosure;

FIG. 5 is a diagram showing an example of a low delay SPAR FIR band filter used in the SPAR encoder;

FIG. 6 is a diagram showing an example of a low delay asymmetric QMF prototype filter;

FIG. 7 is a diagram showing an example of a prototype filter for converting SPAR FIR filters to QMF domain SPAR FIR filters using the asymmetric prototype filter of FIG. 6;

FIG. 8 is a diagram showing examples of FIR filter lengths after truncation of converted FIR filters according to embodiments of the disclosure;

FIGS. 9A, 9B, 9C, and 9D include diagrams showing examples of magnitudes of filter coefficients of the converted FIR filters according to embodiments of the disclosure;

FIGS. 10A, 10B, 10C, and 10D include diagrams showing examples of the first 400 samples of original SPAR filter impulse responses (solid lines) and their approximation with QMF filters (dashed lines) according to embodiments of the disclosure;

FIG. 11 includes diagrams showing examples of accumulated SPAR filters in the QMF domain and modified accumulated SPAR filters in the QMF domain, with processing in band 8, according to embodiments of the disclosure;

FIG. 12 includes diagrams showing examples of SPAR filter frequency responses (1 ms latency, 12 bands), for a possible design with bandwidths lower than 400 Hz at low center frequencies and a possible design with minimum bandwidth of 400 Hz and band borders adjusted to QMF band borders, according to embodiments of the disclosure;

FIG. 13 is a diagram showing an example of an overlay of (QMF adapted) SPAR encoder filter bands (dashed, 12 bands) and QMF decoder filter bands (solid, 60 bands), according to embodiments of the disclosure;

FIG. 14 is a diagram showing an example of single tap SPAR filters in the QMF domain (magnitude frequency response in QMF Bands) as columns per each SPAR band filter, according to embodiments of the disclosure;

FIG. 15 is a flowchart schematically illustrating an example of a method of low complexity SPAR filter processing in the QMF filter bank domain according to embodiments of the disclosure;

FIG. 16 is a flowchart schematically illustrating another example of a method of low complexity SPAR filter processing in the QMF filter bank domain according to embodiments of the disclosure;

FIG. 17 and FIG. 18 include diagrams showing examples of Signal-to-Noise Ratio (SNR) for decoded binaural signals for IVAS SPAR with and without QMF domain reconstruction, according to embodiments of the disclosure; and

FIG. 19 schematically illustrates an example of an apparatus for implementing methods according to embodiments of the disclosure.

### DETAILED DESCRIPTION

Broadly speaking, the present invention relates to parametric filter bank processing for audio coding where parameters are applied with one filter bank (e.g., SPAR filter bank) at the encoder and parameter application shall be reversed at the decoder with another filter bank (e.g., the complex valued QMF filter bank). The present disclosure solves the problem of the encoder and decoder filter bank mismatch for precise parameter application.

One advantage of using two different filter banks lies in the different performance trade-offs. The filter bank at the encoder may have very low delay but relatively large processing stride due to the required efficient, FFT-based, implementation. On the other hand, the filter bank at the decoder may have higher delay but may have capabilities to apply parameters at a smaller stride which is needed for efficient subsequent processing.

In accordance with the above, embodiments of the present disclosure relate to integration of the SPAR decoding and the SPAR decoder filter bank (as a non-limiting example of a first filter bank domain) into the QMF domain (as a non-limiting example of a second, different, filter bank domain), for example by means of FIR filtering along time in QMF bands.

### System Overview

The FIR filters may be time varying according to the transmitted SPAR parameters. Like the SPAR filter bank operation in the MDFT domain, the weighted sum of all band filters may be run rather than each band filter individually. For complexity reduction the QMF domain FIR filters may be truncated in a QMF band frequency dependent manner. Potentially, some processing can utilize the good frequency resolution SPAR filter bank and efficiently implemented by merging the processing with SPAR filters (and still take advantage of the relatively high time resolution of the QMF domain). Other processing steps may just run in the QMF domain after SPAR filtering.

Even though it may have to be noted that the QMF filter bank should have near perfect reconstruction characteristics and have sufficiently large aliasing rejection to allow for high quality signal modification, these requirements must be met anyways if the QMF domain is used for signal modification.

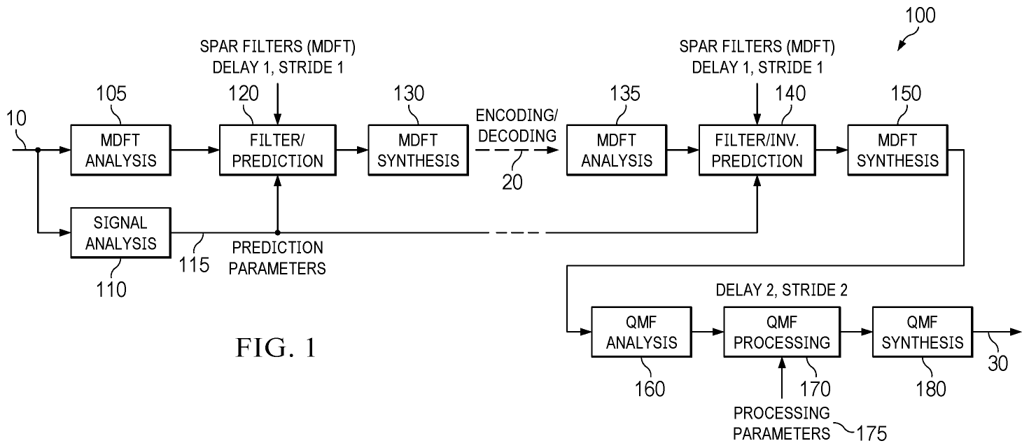

FIG. 1 schematically illustrates an example of a default IVAS SPAR system 100 with subsequent QMF domain processing.

At the encoder, a multichannel audio signal 10 is input to MDFT Analysis Block 105 for applying a SPAR MDFT filter bank (as a non-limiting example of a first filter bank). The multichannel audio signal 10 is also input to Signal Analysis Block 110 that generates prediction parameters (e.g., SPAR parameters, gain parameters) 115 for predicting audio channels (second audio channels) other than an audio channel relating to a transport channel (first audio channel) from the audio channel relating to the transport channel. The output of the MDFT Analysis Block 105 is input to a Filter/Prediction Block 120, at which the prediction parameters 115 are used for generating predictions for the second channels and for generating, based on the predictions, residuals for the second channels (e.g., residuals with respect to a reconstructed version of the first channel). The first channel signal and the residual signals are then provided to MDFT Synthesis Block 130 that performs the inverse operation of the MDFT Analysis Block 105. The prediction parameters 115 are also provided to an output of the decoder, to be output as metadata.

Accordingly, the encoder outputs a representation 20 of the multichannel audio signal comprising a first channel (e.g., a waveform-coded version of the first channel) and metadata relating to a second channel. Potentially, the representation may relate to multiple second channels, but the description below will be limited to a single second channel, for reasons of conciseness and without intended limitation. The metadata comprises, for each of a plurality of first bands of the first filter bank, a respective prediction parameter for making a prediction for the second channel based on the first channel in that first band. The representation may further include a residual for the second channel.

In alternative implementations, instead of transmitting the residual for the second channel, active downmixing may be performed. The transmitted first channel in this case may be generated at the encoder by time and frequency varying downmixing using the first filter bank (e.g., SPAR filter bank).

At the decoder, an MDFT is applied by MDFT Analysis Block 135, inverse prediction is performed by Filter/Inverse Prediction Block 140 using the prediction parameters 115 and the filters of the encoder's MDFT Analysis Block 105. Specifically, in each MDFT band, predictions for the second channels are generated based on the respective filtered version of the first channel and respective ones of the prediction parameters, which can be used for reconstruction of the second channels together with the residuals for the second channels. The inverse of the processing of the MDFT Analysis Block 135 is then performed by MDFT Synthesis Block 150. Accordingly, the processing of the Filter/Inverse Prediction Block 140 may be said to be the inverse of the processing of the Filter/Prediction Block 120.

In implementations using active downmixing, the active downmixing may be at least partly undone by time and frequency varying scaling based on transmitted prediction parameters at the decoder, using the same filter bank processing techniques.

The output of the MDFT Synthesis Block 150, for example a reconstructed multichannel audio signal is then input to a QMF Analysis Block 160 for applying a QMF analysis filter bank (as a non-limiting example of a second filter bank). In the QMF domain, QMF processing as desired is applied to the output of QMF Analysis Block 160 by QMF Processing Block 170, optionally using processing parameters 175. The result thereof is input to QMF Synthesis Block 180 for applying a QMF synthesis filter bank corresponding to (e.g., inverting) the aforementioned QMF analysis filter bank. Thereby, a reconstructed and processed multichannel audio signal 30 is generated.

The processing chain of the default IVAS SPAR system 100 of FIG. 1 may have high computational complexity at the decoder side, as it requires MDFT analysis and synthesis, followed by QMF analysis and synthesis. Additionally, the processing chain may have a delay that corresponds to the combined delay of the SPAR filter bank and the QMF filter bank.

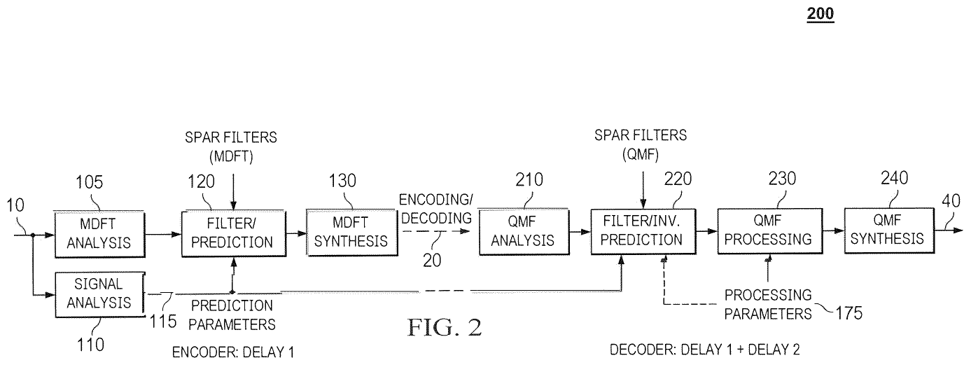

FIG. 2 schematically illustrates an example of a modified IVAS SPAR System 200 for integrated QMF domain SPAR decoding and processing according to embodiments of the disclosure.

Blocks 105, 110, 120, and 130 (i.e., the encoder) may be identical to the corresponding blocks in the default IVAS SPAR system 100 of FIG. 1. At the decoder side, the representation 20 of the multichannel audio signal is input to a QMF Analysis Block 210, which may have the same functionality as QMF Analysis Block 160. Differently from the default IVAS SPAR system 100, inverse prediction is then performed in the QMF domain by Filter/Inverse Prediction Block 220, that takes the prediction parameters (e.g., SPAR parameters) 115 and the filters of the encoder's MDFT Analysis Block 105 as inputs. Subsequently, QMF processing as desired is applied at QMF processing Block 230. A QMF synthesis filter bank corresponding to the QMF analysis filter bank of the QMF Analysis Block 210 is applied to the processing result at a QMF Synthesis Block 240, which finally outputs a reconstructed and processed multichannel audio signal 40.

In some implementations, the encoder does not transmit (prediction) residuals to the decoder. In this case, the QMF domain processing at the decoder may include filling up missing energy with the decorrelated first channel (e.g., W) signal. The decorrelated signal may derived using the transmitted parameters. In the case of active downmixing, the QMF domain processing may involve active mixing to at least partly reverse the active downmixing.

FIG. 1 and FIG. 2 also give indications of delays and time strides. In the default and modified IVAS SPAR systems of FIG. 1 and FIG. 2, the following may apply with regard to delays, time strides, and computational complexity:
Delays
   SPAR Filter Delay “Delay 1” may be between 1 ms and 4 ms (e.g., typically 1 ms)
   QMF Analysis-Synthesis Delay “Delay 2” typically may be 2.5 ms to 5.0 ms
   The overall delay of system 100 and system 200 may be the same (Delay 1+Delay 1+Delay 2)
Time Strides
   Stride 2<Stride 1
      SPAR Prediction and Processing Time Stride “Stride 1” in the MDFT domain may be relatively large (e.g., typically 10 ms to 20 ms) to enable most efficient fast convolution with SPAR Filters
      QMF domain stride may be typically 1.25 ms or 1.33 ms or 1 ms and may allow for fine time grid signal modification for example dedicated handling of transients
Computational Complexity
   Complexity of system 100 without QMF analysis-synthesis may be roughly comparable to the complexity of system 200 including QMF analysis-synthesis.

In general, the encoding and decoding process may be explained for the example of two coded audio signals x₁ (first signal relating to the first channel) and x₂ (second signal relating to a second channel). To simplify the labeling of signals, any quantization of signals and parameters is omitted. Also, for simplification, gain parameters (as an example of SPAR parameters or prediction parameters in general) are assumed to be frequency dependent but static over time (e.g., over the duration of one frame).

At the encoder, the first signal x₁ is split into frequency bands using the SPAR filter bank and its FIR filters h_{b} (as an example of the first filter bank). The second signal x₂ is predicted from signal x₁ by applying gain parameters g_{b} in each band for energy compaction. Then, the prediction residual of x₂ is calculated, and x₁ and the prediction residual of x₂ are converted back to the broad band time domain by SPAR filter bank synthesis, yielding x′₁ and x′₂. The obtained signals x′₁ and x′₂ are then transmitted along with the gain parameters (as an example of SPAR parameters or prediction parameters in general) in the bit stream.

At the decoder in the IVAS SPAR system 100 of FIG. 1 the encoder processing is reversed using the SPAR filter bank and the transmitted gain parameters (as examples of SPAR parameters or prediction parameters in general) yielding the reconstructed signals x″₁ and x″₂. For subsequent processing, QMF analysis is applied to these signals, adding delay and computational complexity.

At the decoder in modified IVAS SPAR system 200 of FIG. 2 the encoder processing is reversed in the QMF domain using the QMF domain SPAR filters and gain parameters. Additional processing in the QMF domain can either be merged with SPAR signal reconstruction or happen as a second processing step in the QMF domain.

### Processing Details

Next, examples of implementation details for the above processing in example systems 100 and 200 will be described.

### Notation

It is understood that all signals and filters are defined for arbitrary integer arguments by extension with zeros for arguments outside their support, defined by the range explicitly populated by finite extent data.

### SPAR Filter Bank

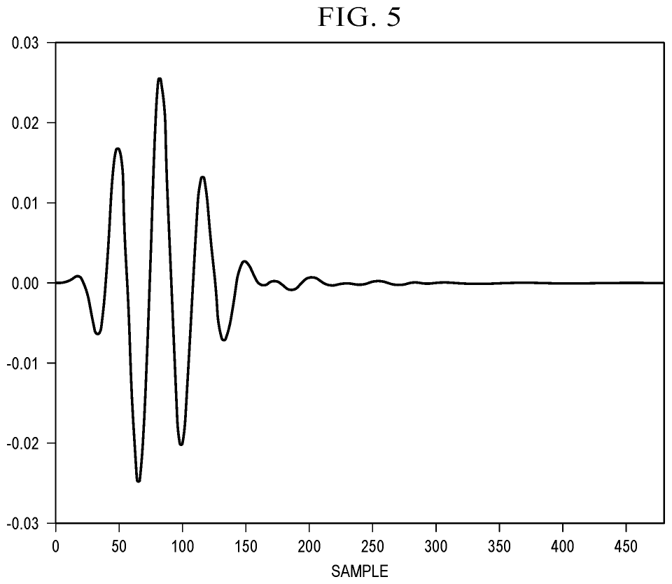

The SPAR filters of the SPAR filter bank may be FIR band pass filters. Their length may be 960 or 480 or 240 taps, for example. Further, center frequencies and bandwidths may be motivated by auditory perception. The FIR filters form a perfect reconstruction filter bank in the sense that they sum up to a delayed Dirac pulse (delay typically 1 or 2 or 4 ms, for example). The filter bank synthesis operation thus may be just a sum of the banded signals. The FIR filtering can be implemented via fast convolution using the MDFT. Band modification with parameters may happen in the MDFT domain and subsequent time domain cross-fade may be applied to avoid jumps between parameter sets. The SPAR filter bank may be perfect or near-perfect reconstructing, such that the SPAR filter bank impulse response h may be given as

$$h ( n ) = {\sum }_{b = 0}^{B - 1} {h}_{b} ( n ) \approx δ ( n - {D}_{1} ) , \qquad ( 1 )$$

where B is the number of SPAR frequency bands (e.g., typically 12), D₁ is the SPAR filter bank delay, and h_{b} are the SPAR FIR band filters. An example of such filter is shown in the diagram of FIG. 5.

The SPAR filter bank response in the case when gain parameters (as examples of SPAR parameters or prediction parameters in general) are applied in each frequency band may be given by

$${h}^{g} ( n ) = {\sum }_{b = 0}^{B - 1} {h}_{b} ( n ) {g}_{b} \qquad ( 2 )$$

where g_{b} are gains (SPAR parameters, prediction parameters) per frequency band b.

### QMF Filter Bank

A time domain signal x can be transformed into the complex QMF domain X for example via

$${X}_{l} ( k ) = {\sum }_{n = 0}^{N - 1} p ( n ) x ( kS - n ) exp ( j \frac{π}{L} ( l + 0.5 ) ( n - \frac{D}{2} ) ) , \qquad ( 3 )$$

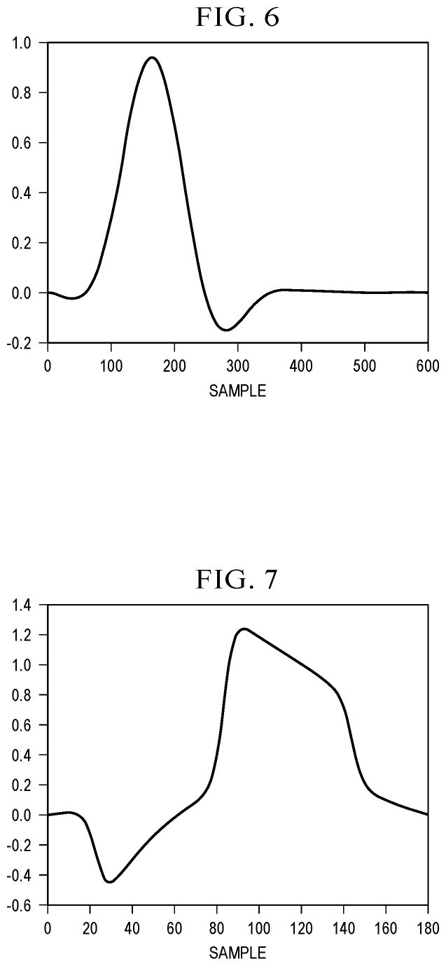

with l=0, 1, . . . , L−1, where N is the length of the prototype filter p which may be non-zero for n=0, 1, . . . , N−1 and zero otherwise. L is the number of QMF frequency channels (e.g., typically L=60), S is the processing stride in samples, k refers to the time slot index, and D is the analysis-synthesis delay in samples (delay with sample-by-sample processing). An example for the prototype filter is shown in the diagram of FIG. 6.
In general, this may be expressed in more compact form with the QMF analysis operator as

$$X = {QMF}_{A} \{ x \} . \qquad ( 4 )$$

A time domain signal x′ may be reconstructed from the QMF representation X for example via

$${x}^{′} ( n ) = RE \{ {\sum }_{k = - ∞}^{∞} {\sum }_{l = 0}^{L - 1} p ( n - kS ) {X}_{l} ( k ) exp ( j \frac{π}{L} ( l + 0.5 ) ( n - kS - \frac{D}{2} ) ) \} \qquad ( 5 )$$

In general, this may be expressed in more compact form with the QMF synthesis operator as

$${x}^{′} = {QMF}_{S} \{ X \} . \qquad ( 6 )$$

The QMF analysis-synthesis system is assumed to be near-perfect reconstructing with a delay of D₂ samples in systems 100, 200 of FIG. 1 and FIG. 2, for example

$${x}^{′} ( n ) \approx x ( n - {D}_{2} ) \\ with {D}_{2} = D - S + 1. \qquad ( 7 )$$

The conversion of SPAR band filters h_{b} into a QMF representation (as an example of a second filter bank representation) Hₗ^{b} for QMF band l and SPAR Filter b may be expressed in compact form with the QMF converter operator (described in more detail below in section Filter Conversion below)

$${H}^{b} = {QMF}_{C} \{ {h}_{b} \} . \qquad ( 8 )$$

The SPAR filter bank response in the QMF domain is the summation over all SPAR filters, for example

$${H}_{l} ( k ) = {\sum }_{b = 0}^{B - 1} {H}_{l}^{b} ( k ) \qquad ( 9 )$$

and similarly, in the case when SPAR gain parameters (as examples of prediction parameters) are applied in each SPAR frequency band,

$${H}_{l}^{g} ( k ) = {\sum }_{b = 0}^{B - 1} {H}_{l}^{b} ( k ) {g}_{b} \qquad ( 10 )$$

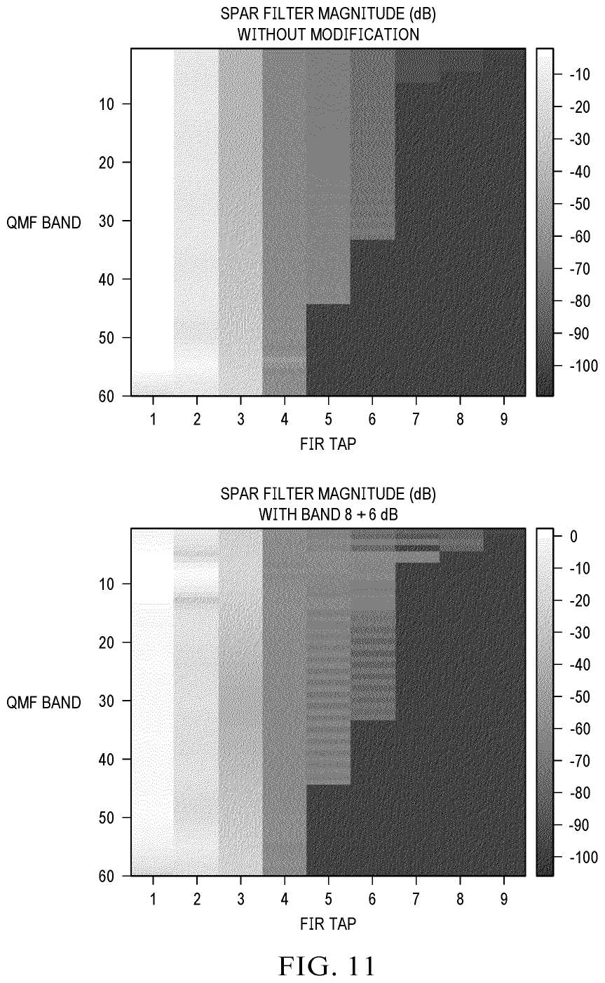

An example of such a SPAR filter bank response in the QMF domain is shown in the bottom panel of FIG. 11.

The SPAR filter bank delay may be modeled in the QMF domain using the converter as

$${H}^{δ} = {QMF}_{C} \{ δ ( n - {D}_{1} ) \} \qquad ( 10 a )$$

### Signal Processing

The encoder signals may be computed for example as

$${x}_{1}^{′} ( n ) = {x}_{1} ( n - {D}_{1} ) \qquad ( 11 )$$

$${x}_{2}^{′} ( n ) = {x}_{2} ( n - {D}_{1} ) - {\sum }_{k = 0}^{{N}_{h} - 1} {h}^{g} ( k ) {x}_{1} ( n - k ) \qquad ( 12 )$$

where Nₕ is the length of the SPAR FIR filters.

Accordingly, the prediction for the second channel signal may be generated based on the filters of the first filter bank (first filters) and the prediction parameters (e.g., in the form of the filter h^{g}(k)). This prediction may be represented by a time-domain signal, as in the example of equation (12). The residual x₂′ for the second channel may then be generated by subtracting the prediction from the second channel signal x₂, where necessary with appropriate delay, in the time-domain. That is, the prediction may be given, for example, by the second term on the right-hand side of equation (12).

The residual signal x₂′ may alternatively be obtained in the SPAR filter bank domain as

$${x}_{2}^{′} ( n ) = {\sum }_{b = 0}^{B - 1} {\sum }_{k = 0}^{{N}_{h} - 1} {h}_{b} ( k ) {x}_{2} ( n - k ) - {h}_{b} ( k ) {g}_{b} {x}_{1} ( n - k ) \qquad ( 12 a )$$

However, this implementation is computationally more expensive than the implementation of equation (12) and may result in larger reconstruction errors if the SPAR filter bank is not perfect reconstruction.

In particular, the residual x₂′ of the second channel signal may be calculated based on the second channel signal x₂ and a reconstruction of the second channel, the latter calculated based on the prediction parameters and the first channel signal x₁.
In case of active downmixing the transmitted signal may be computed as

$${x}_{1}^{′} ( n ) = {\sum }_{i = 1}^{S} {\sum }_{b = 0}^{B - 1} {\sum }_{k = 0}^{{N}_{h} - 1} {h}_{b} ( k ) {g}_{b}^{i} {x}_{i} ( n - k ) \qquad ( 12 b )$$

where S corresponds to the number of encoded signals, in our example S=2, and the factors g_{b} correspond to mixing weights with respect to frequency band b and signal i. An example method of determining the mixing weights is described in published international patent application WO 2022/120093 A1, which is hereby incorporated by reference in its entirety.

The decoder signals in system 100 of FIG. 1 may be computed as

$${x}_{1}^{″} ( n ) = {x}_{1}^{′} ( n - {D}_{1} ) \qquad ( 13 )$$

$${x}_{2}^{″} ( n ) = {x}_{2}^{′} ( n - {D}_{1} ) + {\sum }_{k = 0}^{{N}_{h} - 1} {h}^{g} ( k ) {x}_{1}^{′} ( n - k ) \qquad ( 14 )$$

The decoder signals in system 200 of FIG. 2 may be computed by first transforming into the QMF domain via

$${X}_{1}^{′} = {QMF}_{A} \{ {x}_{1}^{′} \} \qquad ( 15 )$$

$${X}_{2}^{′} = {QMF}_{A} \{ {x}_{2}^{′} \} \qquad ( 16 )$$

and then running the SPAR filter bank, for example as

$${X}_{1 , l}^{″} ( m ) = {\sum }_{k = 0}^{{N}_{l} - 1} {H}_{l} ( k ) {X}_{1 , l}^{′} ( m - k ) \qquad ( 17 )$$

$${X}_{2 , l}^{″} ( m ) = {\sum }_{k = 0}^{{N}_{l} - 1} {H}_{l}^{δ} ( k ) {X}_{2 , l}^{′} ( m - k ) + {H}_{l}^{g} ( k ) {X}_{1 , l}^{′} ( m - k ) \qquad ( 18 )$$

where Nₗ is the length of the QMF domain SPAR filter in the QMF channel l.

In the case when no residual signal is transmitted the signal can be reconstructed as

$${X}_{2 , l}^{″} ( m ) = {\sum }_{k = 0}^{{N}_{l} - 1} {H}_{l}^{D} ( k ) {X}_{1 , l}^{{D}^{′}} ( m - k ) + {H}_{l}^{g} ( k ) {X}_{1 , l}^{′} ( m - k ) \qquad ( 18 a )$$

where X_{1,l}^{D′} refers to a decorrelated version of X_{1,l}′ and Hₗ^{D} to filters that are designed to fill up missing energy. In the case of active downmixing at the encoder side, the downmix signal is reconstructed as

$${X}_{1 , l}^{″} ( m ) = {\sum }_{k = 0}^{{N}_{l} - 1} {H}_{l}^{s ( g )} ( k ) {X}_{1 , l}^{′} ( m - k ) \qquad ( 18 b )$$

where Hₗ^{s(g)} refer to filters which scale the transmitted downmix signal in every frequency band l for example to correctly reconstruct energy. Example details of the reconstruction are described in U.S. Pat. No. 11,450,330, which is hereby incorporated by reference in its entirety.

Finally, the time domain decoded signals can be computed via QMF synthesis, for example as

$${x}_{1}^{′′′} = {QMF}_{S} \{ {X}_{1}^{″} \} \qquad ( 19 )$$

$${x}_{2}^{′′′} = {QMF}_{S} \{ {X}_{2}^{″} \} \qquad ( 20 )$$

### Example Method of Processing a Representation of a Multichannel Audio Signal

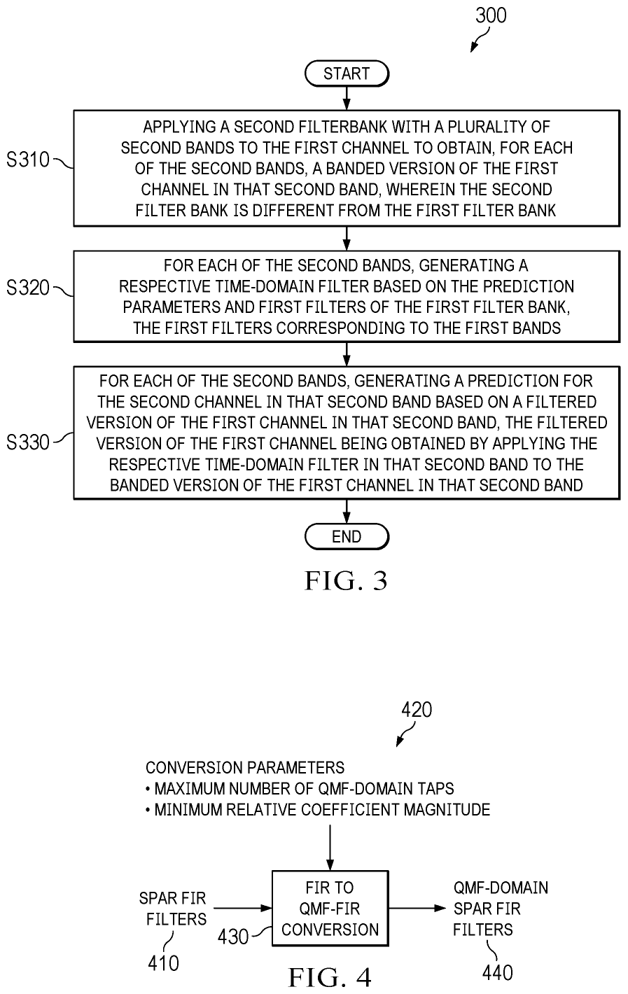

An example of a method 300 of processing (e.g., SPAR decoding) a representation of a multichannel audio signal (e.g., a First Order Ambisonics, FOA, or Higher Order Ambisonics, HOA, audio signal) using techniques according to the present disclosure is shown in the flowchart of FIG. 3. Method 300 comprises steps S310 through S330. These steps may be performed repeatedly, for example for each frame of the multichannel audio signal.

In line with the above, it is understood that the representation comprises a first channel (e.g., a waveform-coded version of the first channel, corresponding to signal x₁) and metadata relating to a second channel (e.g., corresponding to signal x₂). Potentially, the representation may relate to multiple second channels, and the below discussion may be readily extended to such cases. The metadata comprises, for each of a plurality of first bands of the first filter bank, a respective prediction parameter (e.g., SPAR parameter, or gain parameter) for making a prediction for the second channel based on the first channel in that first band. The first filter bank may be a SPAR filter bank, for example, comprising FIR band filters and using an MDFT. The representation may further include a residual for the second channel.

At step S310, a second filterbank with a plurality of second bands is applied to the first channel to obtain, for each of the second bands, a banded version of the first channel in that second band. It is understood that the second filter bank is different from the first filter bank that had been used in the process of generating the representation (e.g., at the encoder). The second filter bank may be a QMF filter bank, for example.

At step S320, for each of the second bands, a respective time-domain filter is generated based on the prediction parameters and first filters of the first filter bank. The first filters correspond to the first bands. In one example, the time-domain filters may be multi-tap FIR filters.

At step S330, a prediction for the second channel is generated based on the banded versions of the first channel and the time-domain filters in the second bands. For example, this may involve, for each of the second bands, generating a prediction for the second channel in that second band based on a filtered version of the first channel in that second band. Therein, the filtered version of the first channel is obtained by applying the respective time-domain filter in that second band to the banded version of the first channel in that second band.

Generation of the time domain filter for a given second band at step S320 may be based on a prototype filter, which may be an asymmetric prototype filter. In particular, step S320 may comprise generating a plurality of adapted (or elementary) first filters based on respective first filters and a prototype filter (e.g., asymmetric prototype filter). Said generation of the time domain filter for a given second band may further comprise taking a weighted sum of the adapted first filters. To this end, the adapted first filters may be weighted with the prediction coefficients (e.g., prediction parameters, SPAR parameters, gain parameters) for the respective first bands. Therein, the processing stride for each tap of the adapted first filters may be equal to or smaller than the number of second bands.

Step S320 of method 300 may be said to relate to a filter conversion step, for example from (MDFT) SPAR FIR filters to QMF-domain SPAR FIR filters. This may correspond to application of the QMF converter operator of equation (8). Details of filter conversion will be described next.

### Filter Conversion

Implementing the integrated QMF domain SPAR decoding and processing, for example as shown in FIG. 2 or FIG. 3, requires conversion of the MDFT SPAR filters used for encoding into the QMF domain (e.g., via the filter conversion operator of equation (8), H=QMF_{c}{h}), or in general, conversion of the filters of a first filter bank domain into a second, different, filter bank domain, for example by means of FIR filtering along time in the bands of the second filter bank domain.

An example of filter conversion, for example from (MDFT) SPAR FIR filters to QMF-domain SPAR FIR filters is schematically shown in FIG. 4. In this example, the SPAR FIR filters 410 are subjected to FIR to QMF-FIR conversion at block 430, to generate QMF-domain SPAR FIR filters. Block 430 may take a set of conversion parameters 420 as additional input. These conversion parameters 420 may include, for example, an indication of the maximum number of QMF-domain taps and/or an indication of a minimum relative coefficient magnitude. Based on the conversion parameters 420, the filter conversion at block 430 may comprise, for example, truncation of filters as detailed below.

Broadly speaking, in the filter conversion for each SPAR filter a set of complex-valued FIR filters is derived, one for each QMF band. There may be 60 QMF bands in total, for example. When applied in the QMF domain, this approximates the operation of FIR filtering with one SPAR filter and subsequent QMF analysis. To mimic parameter modification (e.g., prediction) in all SPAR bands and filter bank synthesis, (e.g., 60) complex-valued FIR filters, one for each QMF band, can be derived by summing (e.g., by filter bank synthesis) over the (e.g., 12) parameter-modified complex-valued FIR filters per QMF band. For the broadband SPAR FIR to QMF domain FIR conversion, first a new prototype filter is derived based on a least squares error objective based on the QMF prototype, the processing stride, the QMF-analysis-synthesis delay, and number of QMF bands. This new prototype typically may have a length of 3 times the processing stride, for example, and is in general asymmetric. Now the QMF domain complex-valued FIR filters can be computed by running a QMF analysis using this new prototype filter with one SPAR FIR filter as input.

In general, the new prototype filter (filter converter prototype) for filter conversion may be derived based on the prototype of the second filter bank.

### Prerequisites and Notation

As described above, the prototype filter p of the QMF synthesis filter bank may be assumed to have support on {0, 1, . . . , N−1}. Further, let S be the time stride in samples and L the number of subbands of the QMF filterbank (e.g., typically 60). For the modeling used here (e.g., relying on zero-delay filter banks) an acausal analysis prototype filter may be defined for example by

$${p}_{A} ( v ) = p ( D - v ) \qquad ( 21 )$$

Hence, p_{A} has support on {D−N+1, . . . , D}. The parameter D is the delay parameter used in the filterbank design.

### Filter Converter Prototype Computation

This section generally relates to generating a filter converter prototype q (prototype filter for filter conversion) based on the prototype filter p of the second filterbank. As will be described in more detail below, the filter converter prototype q may be generated based on the prototype filter p of the second filterbank by solving one or more least-squares problems, such as least-squares problems involving matrix representations derived from the prototype filter p of the second filterbank.

For example, the following steps may be performed to arrive at a filter converter prototype filter q, supported on {−F, −F+1, . . . , R−F−1}. Hence, R is the length of the filter converter prototype and F is an offset parameter, both in units of samples. First, a cross-correlation may be defined for example by

$${p}_{2} ( v ) = {\sum }_{l = - ∞}^{∞} {p}_{A} ( l ) p ( l + v ) \qquad ( 22 )$$

It can be observed that the infinite sum is in fact finite (over l∈{D−N+1, . . . , D}) and that p₂ is finitely supported.

Second, a finite set of matrices V^{(k)}, k=−K, . . . , K of size S×R may be defined by their elements, for example via

$${v}_{n , m}^{( k )} = \{ \begin{matrix}{p}_{2} ( m - F - 2 kL ) , & if n - m is a multiple of S ; \\ 0 , & otherwise .\end{matrix} \qquad ( 23 )$$

Here, v_{n,m}^{(k)} is indexed by n∈{0, . . . , S−1} and m∈{0, . . . , R−1}. The value of K is chosen so that all entries v_{n,m}^{(k)}=0 if |k|>K.

Finally, the entries of the filter converter prototype filter q can be found for example as the entries of a vector q of size R×1 solving to the least squares problem

$${V}^{( k )} q \approx \{ \begin{matrix}\frac{S}{L} 1 , & k = 0 ; \\ 0 , & k = - K , ... , - 1 , 1 , ... , K .\end{matrix} \qquad ( 24 )$$

Here 1 and 0 denote vectors of size R×1 with all ones or zeros as entries, respectively. For this, it is convenient to stack all matrices V^{(k)} vertically into a matrix V of size (2K+1)S×R and to define a right-hand side vector r of size (2K+1)S×1 for example as follows

$$V = [ \begin{matrix}{V}^{( - K )} \\ ⋮ \\ {V}^{( 0 )} \\ ⋮ \\ {V}^{( K )}\end{matrix} ] , r = \frac{S}{L} [ \begin{matrix}0 \\ ⋮ \\ 1 \\ ⋮ \\ 0\end{matrix} ] \qquad ( 25 )$$

The least squares problem at hand is then Vq≈r, which has the normal equations Mq=V^{T}r with M=V^{T}V, where V^{T} denotes the matrix transpose of V. A small positive number can be added to all the diagonal entries of M prior to the solution of this system of equations for better numerical stability. The entries of the solution vector q may be used the entries of the filter q on {(−F, −F+1, . . . , R−F−1}.

An example design of q with L=S=60, R=180, F=120, D=299, and N=600 is shown in the diagram of FIG. 7.

### Filter Conversion Using the Filter Converter Prototype

Given the filter converter prototype q, the conversion H^{b}=QMF_{c}{h_{b}} of the filter h_{b} may then be defined for example by

$${H}_{l}^{b} ( k ) = {\sum }_{n = - F}^{R - F - 1} {h}_{b} ( n + kS ) q ( n ) exp ( - i \frac{π}{L} ( l + \frac{1}{2} ) n ) \qquad ( 26 )$$

In general, a plurality of adapted first filters Hₗ^{b} may be said to be generated based on respective first filters h_{b} and the filter converter prototype q (prototype filter for filter conversion).

Notably, this method does not introduce additional delay if Hₗ^{b}(k)=0 for k<0, and a sufficient condition for this is that R−F≤S, for example.

### Conventional Filter Conversion

An example of conventional techniques for filter conversion, which is not applicable to the IVAS SPAR framework with integrated QMF processing is described in U.S. Pat. No. 8,315,859 (henceforth referred to as reference document). In particular, the filter conversion of this reference is not applicable to the aforementioned SPAR FIR to QMF-domain SPAR FIR conversion that is particularly relevant for low delay SPAR processing. The filter conversion described there is limited there to the case of
symmetric QMF prototype filters
a QMF filterbank with the same number of subbands as the time stride in samples, i.e., L=S
   On the other hand QMF filter bank designs relevant for low delay processing as used in IVAS SPAR can have
asymmetric QMF prototype filters
oversampling where the number of subbands L can be larger than the time stride S in samples
   By contrast to the cited reference, filter conversion according to the present disclosure specifically allows for filter banks that can have asymmetric QMF prototype filters and/or oversampling where the number of subbands is larger than the time stride in samples.

### Truncation of Converted Filters

Filter conversion (e.g., at step S320 of method 300 or as shown in FIG. 4) may further include truncating a filter length of the time-domain filters (e.g., QMF domain SPAR filter truncation). In particular, in an efficient implementation of the QMF domain SPAR filter bank processing, it may be advantageous to reduce the filter order (e.g., the filter length Nₗ along time slots per QMF frequency channel l) as much as possible by setting filter taps that have a minor impact (e.g., perceptual impact) on the filtering to zero. This may improve computational efficiency for decoding, without, if done correctly, perceptual impact. One way of doing this is explained below.

First a magnitude threshold may be derived for every SPAR band filter in the QMF domain as

$${thr}_{b} = {10}^{( \frac{{L}_{thr}}{20} )} max \vert {H}_{l}^{b} ( k ) \vert \qquad ( 27 )$$

For all k and l=0, 1, . . . , L−1 and a reasonable threshold level Lₜₕᵣ of, for example, −70 dB. Then, for every QMF frequency channel l, the maximum time slot index kₘₐₓ may be found such that

$$\vert {H}_{l}^{b} ( k ) \vert > {thr}_{b} \qquad ( 28 )$$

for b=0, 1, . . . , B−1.
The filter length Nₗ in QMF frequency channel I then may be chosen as Nₗ=kₘₐₓ.

In other words, truncation may proceed as follows:
Define a relative magnitude threshold

$$( e . g . , {thr}_{rel} = {10}^{( \frac{{L}_{thr}}{20} )} )$$

For all SPAR filters
   Convert the respective SPAR filter to QMF domain FIR filters (e.g., one per QMF band)
   Compute magnitude |Hₗ^{b}(k)| of converted FIR coefficients
   Compute the threshold thr_{b} per SPAR filter as the maximum coefficient magnitude scaled by the relative magnitude threshold thrᵣₑₗ
   For all QMF bands
      Find the FIR length such that coefficients beyond this length are below the threshold
      Find the maximum FIR length over all SPAR filters and store same as the truncated filter length Nₗ in that QMF band, for example in a variable num_taps_per_qmf_band.
The information on truncated FIR length (e.g., num_taps_per_qmf_band) can be used for efficient filtering in the QMF domain
   Note: Typically, groups of QMF band-adjacent FIR filters with the same filter lengths can be identified. For example, often multiple FIR filters at the highest frequency QMF bands have the same truncated filter length which can simplify the implementation.

In general, in the terminology of method 300, the filter length of a given time-domain filter after truncation may depend on the respective second band of the time domain filter (e.g., on the respective QMF band l).

Further, in line with the above, generating the time-domain filter for a given second band (e.g., QMF band) may involve generating a respective elementary (or adapted) time-domain filter (e.g., converted FIR filter) in the given second band for each of the first filters (e.g., for each SPAR filer), as well as generating the time-domain filter in the given second band based on the elementary time-domain filters in the given second band and the prediction parameters (e.g., as a weighted sum as described further above). Then, truncation of a time-domain filter for the given second band may be based on threshold values for the filter coefficients of the elementary time-domain filters. Each of these threshold values may correspond to a respective one among the first filters. Further, the threshold value for the elementary time-domain filters for a given first filter may be derived from a maximum magnitude of said elementary time-domain filters in the plurality of second bands. For example, the threshold value for a given first filter may be derived from the maximum coefficient magnitude for the elementary time-domain filters for that first filter, scaled by a relative threshold (e.g., by −20 dB).

Truncating the time domain filters may further involve determining, for each first band (e.g., for each SPAR filter), a maximum magnitude of the (filter coefficients of the) corresponding elementary time-domain filters in the plurality of second bands (e.g., in the plurality of QMF bands). Then, for each first band, a minimum truncated filter length may be determined for the corresponding elementary time-domain filters in the plurality of second bands (i.e., one minimum truncated filter length for each first filter and second band) based on a threshold value derived from said maximum magnitude. Finally, for each second band, the filter length of the time-domain filter in that second band may be determined based on the minimum truncated filter lengths of the elementary time-domain filters (i.e., one for each first filter) in that second band. The filter length may in that second band may be taken as the maximum of the minimum filter lengths.

For example, there may be B first filters of the first filter bank (e.g., B=12 SPAR filters) and L second bands of the second filter bank (e.g., L=60 QMF bands). Then, for first filter b∈0, . . . , B−1, the threshold value thr_{b} may be derived from the coefficients of all the L elementary time-domain filters that are generated for first filter b. This may be done by taking the largest coefficient value and scaling it down by a relative threshold thrᵣₑₗ. Then, for a given second frequency band l∈0, . . . , L−1, there are B such threshold values thr_{b}, b∈0, . . . , B−1, one for each of the B elementary time-domain filters in the second band l (or equivalently, one for each of the B first filters). Applying these threshold values thr_{b} to respective elementary time-domain filters in second band l yields B different minimum filter lengths len_{l,b}, b∈0, . . . , B−1, which are the filter lengths beyond which the coefficients of the elementary time-domain filters in second band l are below their respective threshold value thr_{b}. Then, for second band l a filter length Nₗ for truncation can be determined as the maximum of the minimum filter lengths len_{l,b} in that second band l, i.e.,

$${N}_{l} = {max}_{b ∈ 0 , … , B - 1} ( {len}_{l , b} ) .$$

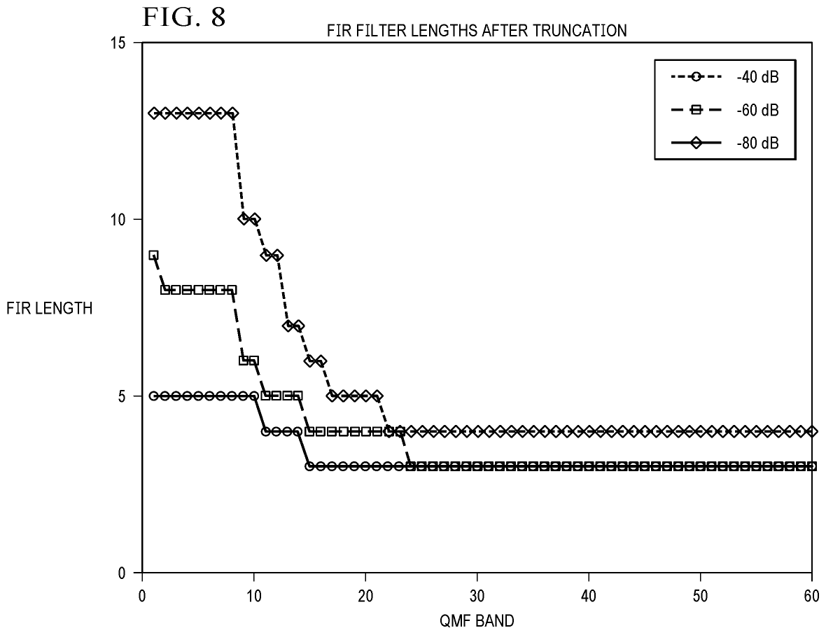

FIG. 8 is a diagram showing examples of FIR filter lengths after truncation of converted FIR filters across QMF bands for different relative thresholds thrᵣₑₗ. The top graph (diamond symbols) corresponds to a relative threshold of −80 dB, the middle graph (square symbols) corresponds to a relative threshold of −60 dB, and the bottom graph (cross symbols) corresponds to a relative threshold of −40 dB. Here, a smaller difference or scaling factor between the maximum coefficient magnitude and the threshold results in shorter filter lengths, and vice versa.

### Filter Conversion to Single-Tap Filters

There may be situations where the computational complexity of multi-tap FIR filtering in the QMF domain is too high. To address this issue, two alternative, low complexity, SPAR parameter processing methods, for example for the QMF adjusted SPAR filter bank, are described next. It is understood that these methods generally apply to first and second filter banks, without being limited to SPAR and QMF filter banks.

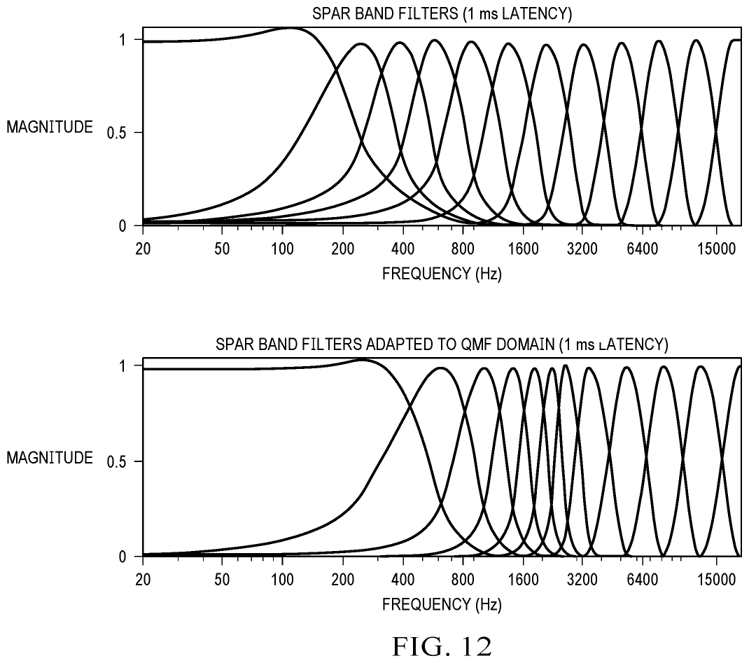

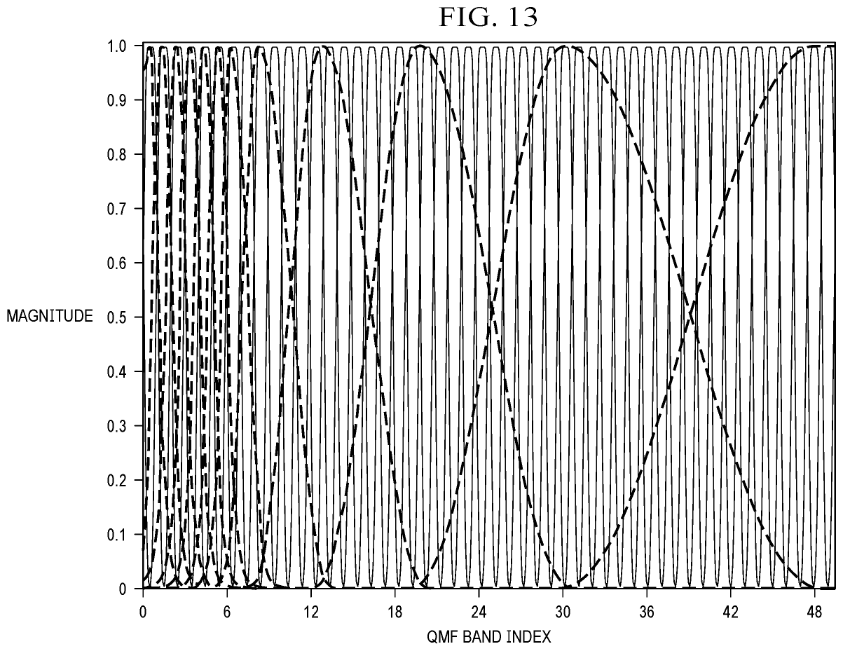

In relation to this, FIG. 12 shows examples of SPAR filter frequency responses (1 ms latency, 12 bands), for a possible design with bandwidths lower than 400 Hz at low center frequencies (top panel) and a possible design with minimum bandwidth of 400 Hz and band borders adjusted to QMF band borders (bottom panel). Further, FIG. 13 shows an example of an overlay of (QMF adapted) SPAR encoder filter bands (dashed, 12 bands) and QMF decoder filter bands (solid, 60 bands). The QMF adjusted SPAR Filter Bank is shown in FIG. 12, bottom panel, and in FIG. 13, dashed curve (e.g., SPAR Filter band borders match QMF band borders, SPAR Filter bandwidths are equal to or greater than the QMF bandwidth).

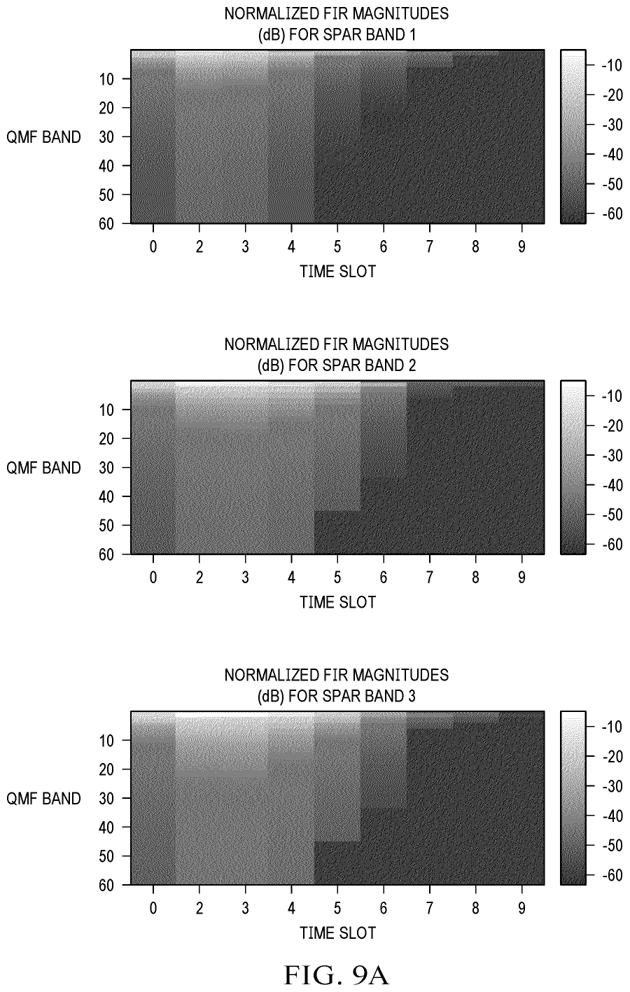

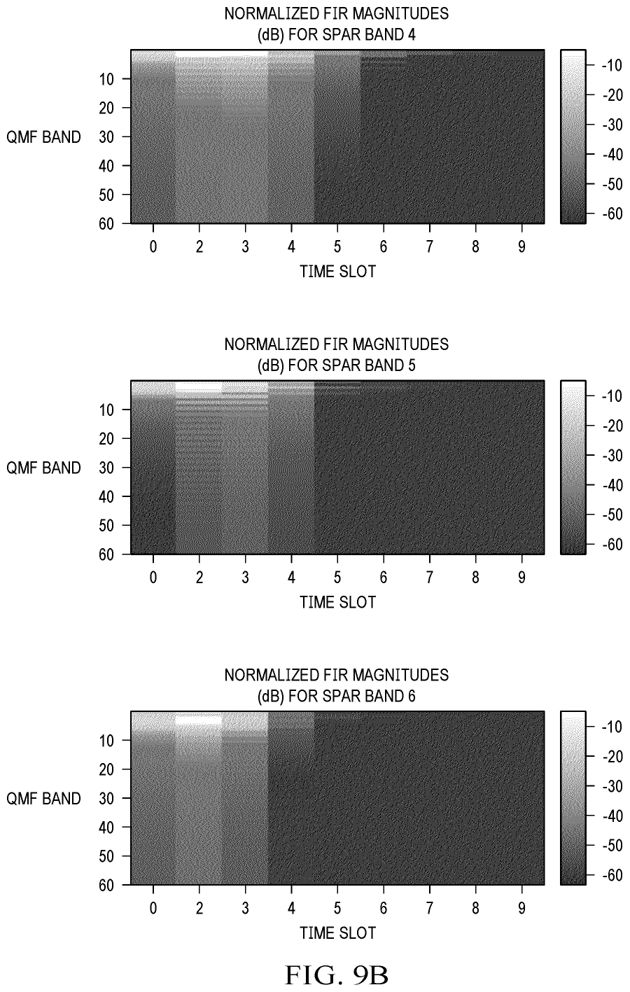

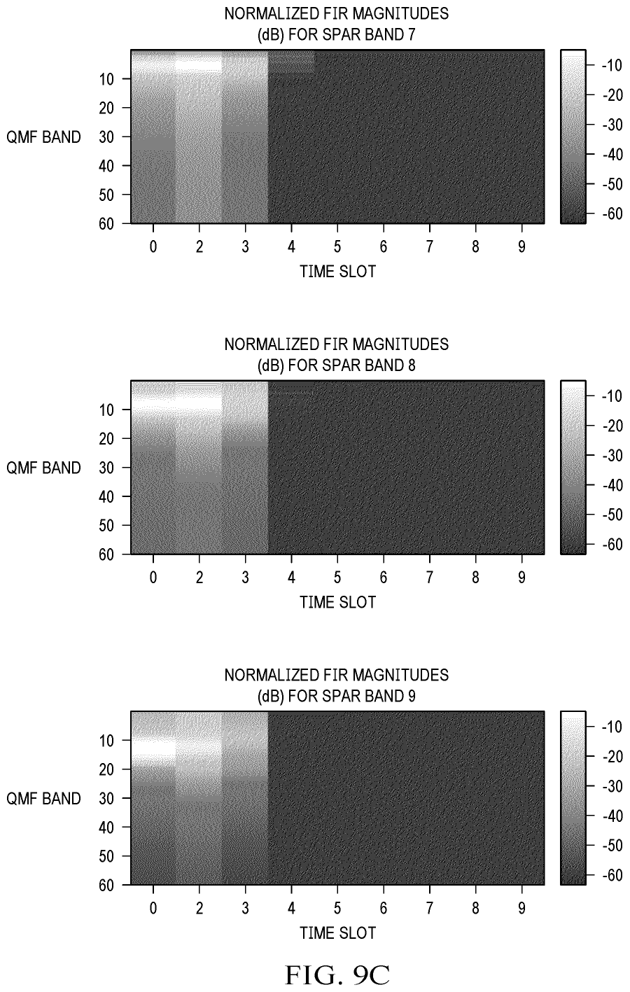

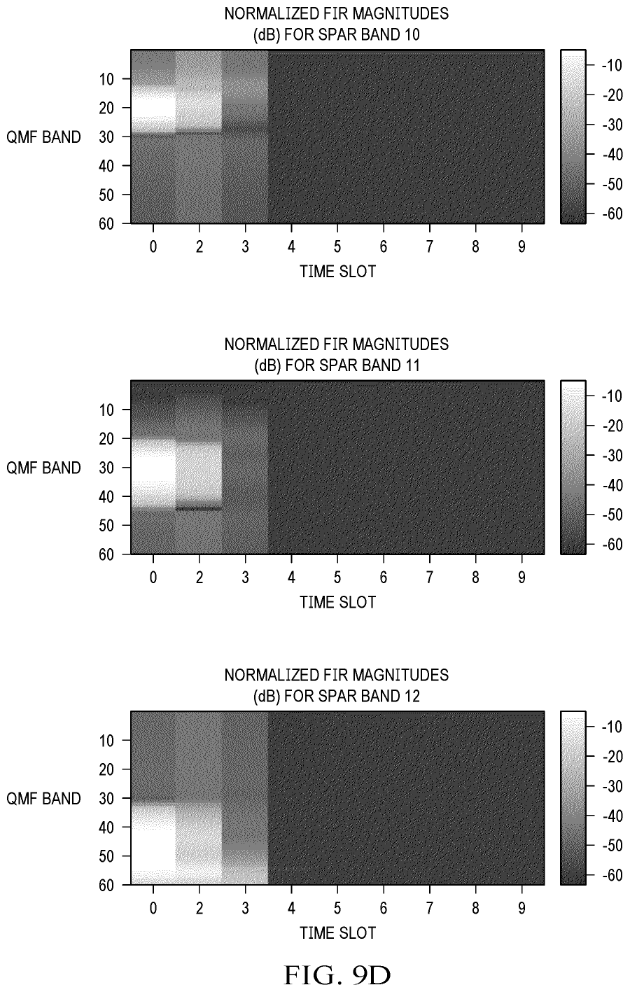

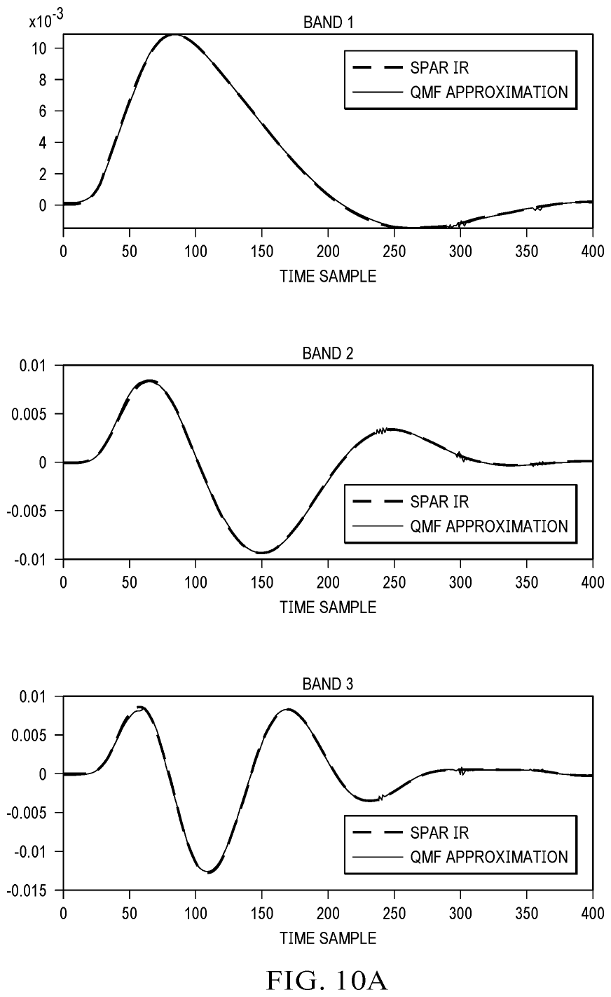

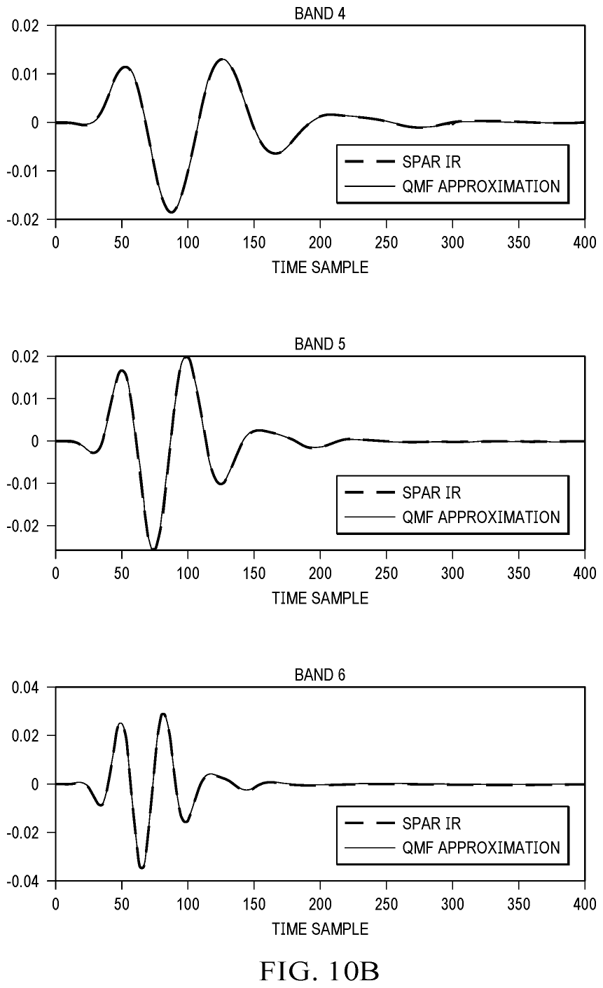

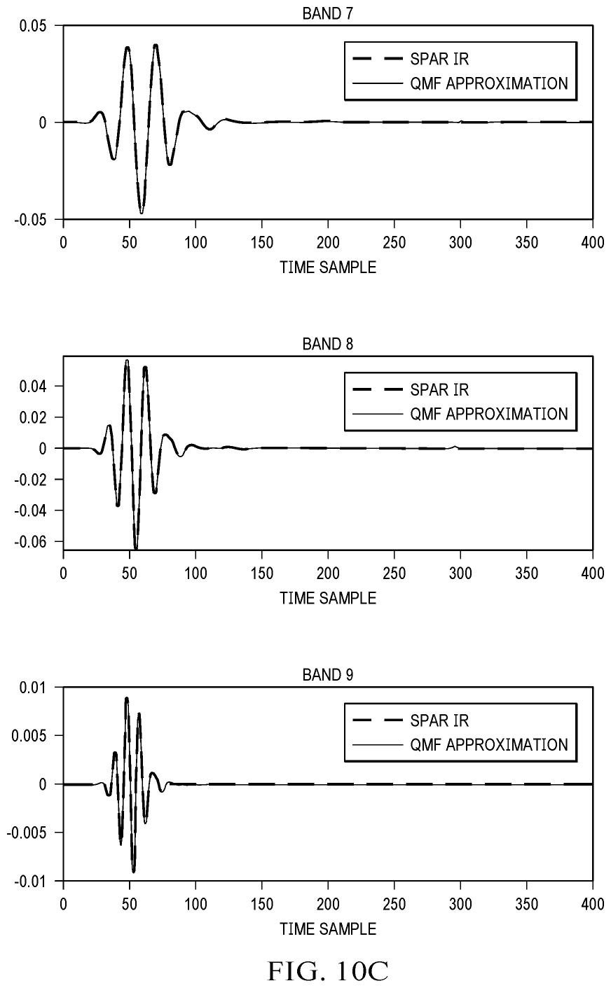

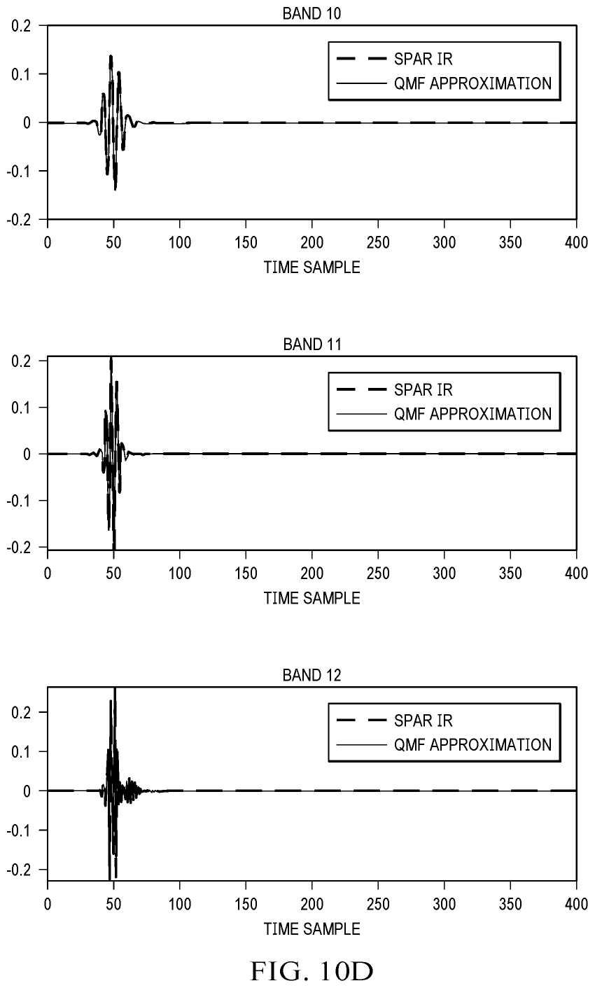

The idea is to approximate the SPAR filter bank band filters by linear phase filters such that the QMF domain multi-tap filters shown in FIG. 9A-D can be represented as real-valued, non-negative single tap filters (i.e., only the first column is non-zero). Then N_{c}=const=0 and the sum in equation. (17) vanishes, only tap n=0 remains. For reference, FIGS. 10A, 10B, 10C, and 10D include diagrams showing examples of the first 400 samples of original SPAR filter impulse responses (solid lines) and their approximation with QMF filters (dashed lines) according to embodiments of the disclosure.

When approximating by real-valued single tap filters, the overall delay of system 200 (see FIG. 2) reduces to Delay 1+Delay 2 (compared to Delay 1+Delay 1+Delay 2).

That said, in some implementations of the present disclosure the time-domain filters may be single-tap FIR filters. It is understood that this may require a processing step for generating the single-tap FIR filters.

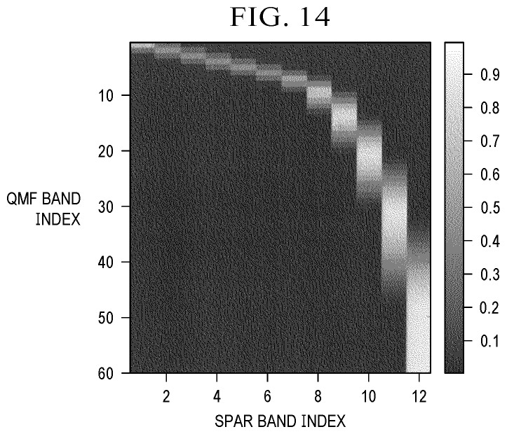

If the single tap filter coefficients are arranged in columns in a matrix M of size [C×B] they can be visualized as shown in FIG. 14, relating to an example of single tap SPAR filters in the QMF domain (magnitude frequency response in QMF Bands) as columns per each SPAR band filter.

### Computation of Zero'Th-Order QMF Domain SPAR Filters

The real-valued coefficients of the single tap filters can be computed with the help of the (modified) Fourier Transform as

$${H}_{l}^{b} = \frac{{M}_{l}^{b}}{{\sum }_{b = 0}^{B - 1} {M}_{l}^{b}} \\ with \qquad ( 29 )$$

$${M}_{l}^{b} = \sqrt{{\sum }_{f = lN / L}^{( l + 1 ) N / L} {\vert {\sum }_{n = 0}^{{N}_{h} - 1} {h}_{b} ( n ) {e}^{- j π ( f + 0.5 ) n / N} \vert}^{2}} \qquad ( 30 )$$

where N/L is an integer number.

Notably, the overall SPAR Filter Bank response of equation (9) reduces to

$${H}_{l} = {H}_{l}^{δ} = const = 1. \qquad ( 31 )$$

To reduce complexity of computing the filter bank response with gain parameters, for example as per equation (10), the number of non-zero values in Mₗ^{b} may be limited to the most significant ones. This may be done for example by setting

$${M}_{l}^{b} = max ( {M}_{l}^{b} - 0.3 , 0 ) \qquad ( 32 )$$

for all QMF bands l and all SPAR bands b.

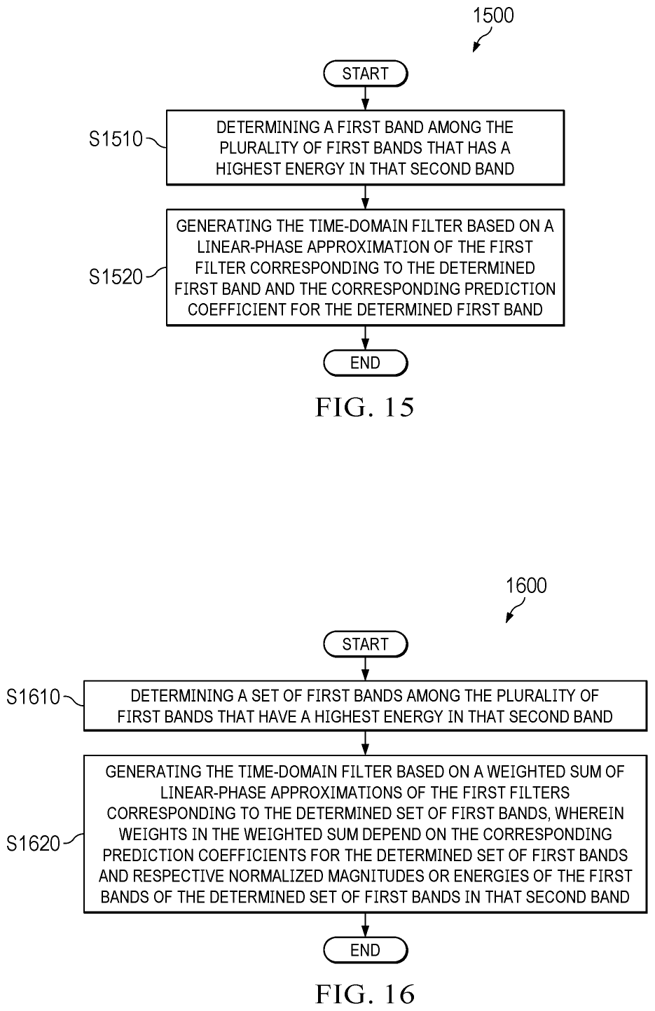

Further, in some embodiments generating the time-domain filter for a given second band may comprise steps S1510 and S1520 of method 1500 shown in FIG. 15. At step S1510, a first band among the plurality of first bands is determined that has a highest energy in that second band. And then, at step S1520, the time-domain filter is generated based on a linear-phase approximation of the first filter corresponding to the determined first band and the corresponding prediction coefficient for the determined first band.

Yet another simplification and complexity reduction can be achieved for those QMF frequency bands to which only a single SPAR Filter significantly contributes, as for example for the lowest 7 QMF frequency bands. This case is shown in the example of FIG. 13. Defining such a matching SPAR band as by for the QMF band l, then

$${M}_{l}^{b} = \{ \begin{matrix}1 , & b = {b}_{l} \\ 0 , & b \neq {b}_{l}\end{matrix} \qquad ( 33 )$$

Further, in some embodiments generating the time-domain filter for a given second band may comprise steps S1610 and S1620 of method 1600 shown in FIG. 16. At step S1610, a set of first bands among the plurality of first bands is determined that have a highest energy in that second band. And then, at step S1620, the time-domain filter is generated based on a weighted sum of linear-phase approximations of the first filters corresponding to the determined set of first bands, wherein weights in the weighted sum depend on the corresponding prediction coefficients for the determined set of first bands and respective normalized magnitudes or energies of the first bands of the determined set of first bands in that second band.

In one implementation, the SPAR filter response for some QMF bands may be computed using equation (32+x) while for remaining QMF bands equation (33+x) may be used.

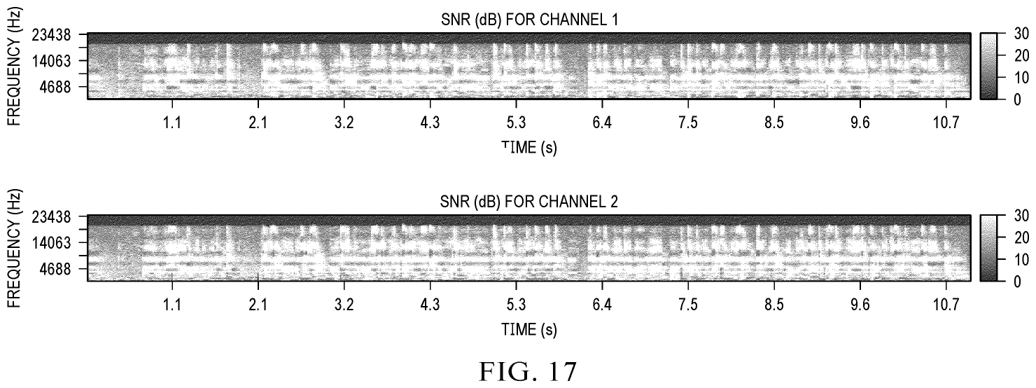

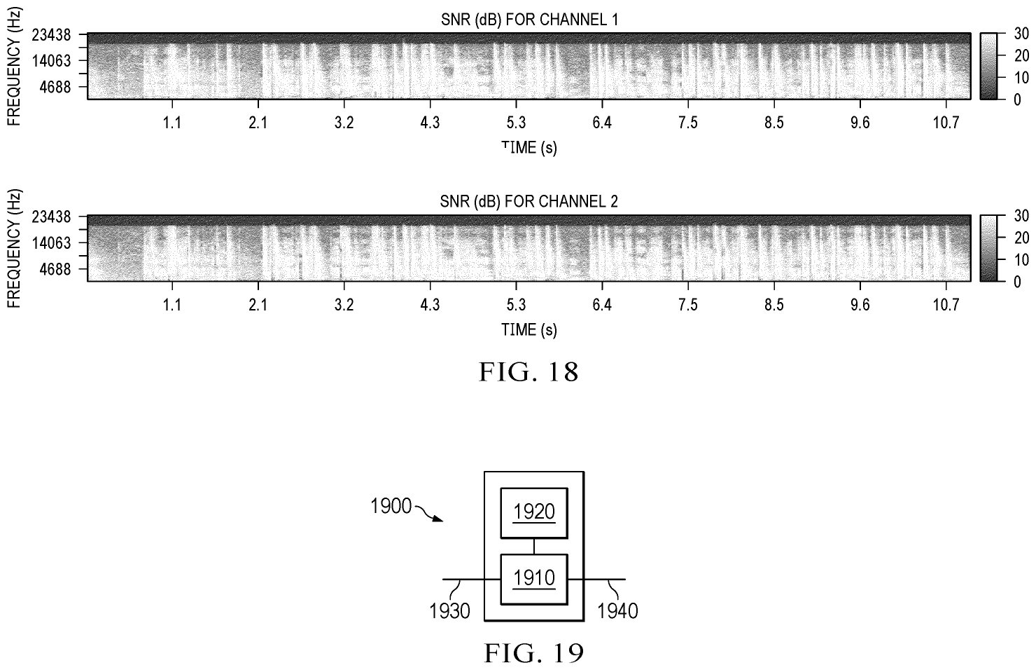

Finally, FIG. 17 and FIG. 18 include diagrams showing examples of SNR for decoded binaural signals for IVAS SPAR with and without QMF domain reconstruction. FIG. 17 relates to the case of using a modified SPAR filter bank adapted to the QMF domain and brick wall application of SPAR parameters in QMF bands, while FIG. 18 relates to the case of the original SPAR filter bank and multi-tap SPAR filtering in the QMF domain according to embodiments of the disclosure.

### Direct Filter Conversion

An alternative conversion method, with higher computational complexity, is to compute the coefficients of Hₗ^{b} for a given SPAR frequency band b with a predetermined length Nₗ in each QMF channel l by the following steps. Define by Y=Φ_{F}{X} the operation of filtering in the QMF domain with coefficients Fₗ(k) as

$${Y}_{l} ( m ) = {\sum }_{k = 0}^{{N}_{l} - 1} {F}_{l} ( k ) {X}_{l} ( m - k ) , \qquad ( 34 )$$

and define by y=Ψ_{F}{x} the combined effect of QMF analysis, filtering in the QMF domain, and QMF synthesis, so Ψ_{F}=QMF_{S}·φ_{F}·QMF_{A}. The design goal for is that Ψ_{F} with F=H^{b} approximates filtering with the SPAR filter h_{b} up to a delay D₃, (a design parameter that may be chosen close to the QMF filter bank delay D₂). Consider the input signal xₚ(k)=δ(k−p) for each p=0, 1, . . . , S−1. xₚ(k) may be said to represent elementary signals with single non-zero samples (of value 1) at respective sample positions. For each l=0, 1, . . . , L−1 and k=0, 1, . . . , Nₗ−1, the result of applying Ψ_{F} on xₚ with the single-tap filter F_{λ}^{(re)}(κ)=δ(λ−, κ−k) is denoted by u_{p,l,k} (n). F_{λ}^{(re)}(κ) may be said to represent elementary real-valued single-tap filters for respective single ones of the second bands (e.g., QMF bands) with single non-zero filter coefficients (of value 1) at respective tap positions. u_{p,l,k}(n) may then be said to represent elementary first signals obtainable by applying the second filterbank (e.g., QMF filterbank), the elementary real-valued single-tap filters, and a synthesis filterbank of the second filterbank to the elementary signals. Likewise with the imaginary single-tap filter F_{λ}^{(im)}(κ)=iδ(λ−l, κ−k), the resulting signal is denoted by v_{p,l,k}(n). These F_{λ}^{(im)}(κ) may be said to represent elementary imaginary single-tap filters for respective single ones of the second bands (e.g., QMF bands) with single non-zero filter coefficients (of value i) at respective tap positions. v_{p,l,k}(n) may then be said to represent elementary second signals obtainable by applying the second filterbank, the elementary imaginary single-tap filters, and the synthesis filterbank of the second filterbank to the elementary signals. Writing Fₗ(k)=aₗ(k)+ibₗ(k) with real valued coefficients a and b, the real valued linearity of Ψ_{F} in the coefficients argument F implies that applying Ψ_{F} on xₚ gives the result

$${\sum }_{l = 0}^{L - 1} {\sum }_{k = 0}^{{N}_{l}} ( {a}_{l} ( k ) {u}_{p , l , k} ( n ) + {b}_{l} ( k ) {v}_{p , l , k} ( n ) ) . \qquad ( 35 )$$

The desired result is h_{b} (n−D₃−p), for all p=0, 1, . . . , S−1. If this holds, it will extend to be true for all p due to the shift invariance in steps of S samples of Ψ_{F}, and an implementation of the SPAR filter is thus achieved by using Hₗ^{b}(k)=aₗ(k)+ibₗ(k). The direct filter conversion consists of approximating this situation by finding a least squares solution for a and b to the following problem for p=0, 1, . . . , S−1 and n in a range including the support of h_{b},

$${\sum }_{l = 0}^{L - 1} {\sum }_{k = 0}^{{N}_{l}} ( {a}_{l} ( k ) {u}_{p , l , k} ( n ) + {b}_{l} ( k ) {v}_{p , l , k} ( n ) ) \approx {h}_{b} ( n - {D}_{3} - p ) , \qquad ( 36 )$$

and then setting Hₗ^{b}=aₗ+ibₗ.

Accordingly, a given first filter h_{b} (with appropriate delay) may be approximated by the first and second elementary signals, and (a subset of) the coefficients at and b; may then be used for deriving the adapted first filter Hₗ^{b} in second band l.

### Apparatus for Implementing Methods According to the Disclosure

Finally, the present disclosure likewise relates to an apparatus (e.g., computer-implemented apparatus) for performing methods and techniques described throughout the present disclosure. FIG. 19 shows an example of such apparatus 1900. In particular, apparatus 1900 comprises a processor 1910 and a memory 1920 coupled to the processor 1910. The memory 1920 may store instructions for the processor 1910. The processor 1910 may also receive, among others, suitable input data (e.g., audio input), depending on use cases and/or implementations. The processor 1910 may be adapted to carry out the methods/techniques described throughout the present disclosure (e.g., method 300 of FIG. 3) and to generate corresponding output data 1940 (e.g., a reconstructed multichannel audio signal), depending on use cases and/or implementations.

### SUMMARY OF THE DISCLOSURE

In summary, the present disclosure relates to:
Filter bank processing of a first filter bank (e.g., SPAR filter bank) within the domain of another, second, filter bank (e.g., QMF filter bank), taking advantages of each of the individual filter banks in terms of time and frequency resolution and processing stride
Efficient and low delay SPAR FIR filter conversion to the QMF domain, specifically with an asymmetric QMF prototype filter
Optionally, QMF-band dependent QMF FIR length truncation for complexity reduction
Optionally, QMF domain FIR length truncation based on a threshold relative to the maximum magnitude for the individual filters
Combining SPAR filter bank filtering and signal manipulation

Further, techniques according to the present disclosure may have the following characteristics and advantages:
No need to adapt SPAR filters to QMF banding
Saving computational complexity by avoiding the MDFT-based filter bank processing before QMF analysis

### Interpretation

Aspects of the systems described herein may be implemented in an appropriate computer-based sound processing network environment (e.g., server or cloud environment) for processing digital or digitized audio files. Portions of the adaptive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Specifically, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more electronic processors, such as a microprocessor and/or application specific integrated circuits (“ASICs”). As such, it should be noted that a plurality of hardware and software-based devices, as well as a plurality of different structural components, may be utilized to implement the embodiments. For example, the systems, encoders, decoders, or blocks described in the context of FIG. 1 and FIG. 2 or FIG. 19 above can include one or more electronic processors, one or more computer-readable medium modules, one or more input/output interfaces, and various connections (e.g., a system bus) connecting the various components.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

### ENUMERATED EXAMPLE EMBODIMENTS

Various aspects and implementations of the present disclosure may also be appreciated from the following enumerated example embodiments (EEEs), which are not claims.

EEE1. A method of processing a representation of a multichannel audio signal, wherein the representation comprises a first channel and metadata relating to a second channel, and wherein the metadata comprises, for each of a plurality of first bands of a first filter bank, a respective prediction parameter for making a prediction for the second channel based on the first channel in that first band, the method comprising:
applying a second filterbank with a plurality of second bands to the first channel to obtain, for each of the second bands, a banded version of the first channel in that second band, wherein the second filter bank is different from the first filter bank;
for each of the second bands, generating a respective time-domain filter based on the prediction parameters and first filters of the first filter bank, the first filters corresponding to the first bands; and
generating a prediction for the second channel based on the banded versions of the first channel and the time-domain filters in the second bands.

EEE2. The method of EEE1, wherein generating the prediction of the second channel comprises, for each of the second bands, generating a prediction for the second channel in that second band based on a filtered version of the first channel in that second band, the filtered version of the first channel being obtained by applying the respective time-domain filter in that second band to the banded version of the first channel in that second band.

EEE3. The method according to EEE1 or EEE2, wherein the multichannel audio signal is a First Order Ambisonics, FOA, or Higher Order Ambisonics, HOA, audio signal.

EEE4. The method according to any one of EEE1 to EEE3, wherein the prediction parameters are SPAR parameters.

EEE5. The method according to any one of EEE1 to EEE4, wherein the first filter bank is a SPAR filter bank comprising FIR band filters and uses an MDFT.

EEE6. The method according to any one of EEE1 to EEE5, wherein the second filter bank is a QMF filter bank.

EEE7. The method according to any one of EEE1 to EEE6, wherein the time-domain filters are multi-tap FIR filters.

EEE8. The method according to any one of EEE1 to EEE7, wherein generating the time-domain filter for a given second band comprises:

generating a plurality of adapted first filters based on respective first filters and a prototype filter.

EEE9. The method according to EEE8, wherein for a given second band l the adapted first filter Hₗ^{b} of a first filter h_{b} for a given first band b is calculated as

$${H}_{l}^{b} = {\sum }_{n} {h}_{b} ( n + kS ) q ( n ) exp ( - i \frac{π}{L} ( l + \frac{1}{2} ) n )$$

where q is the prototype filter for filter conversion, S is the stride of the second filterbank, L is the number of second bands, and summation for n is over the support of the prototype filter q for filter conversion.

EEE10. The method according to EEE8 or EEE9, further comprising generating the prototype filter for filter conversion based on a prototype filter of the second filterbank.

EEE11. The method according to EEE10, wherein the prototype filter for filter conversion is generated based on the prototype filter of the second filterbank by solving a least-squares problem.

EEE12. The method according to EEE10 or EEE11 when depending on claim 9, wherein generating the prototype filter for filter conversion comprises:
generating an acausal prototype filter p_{A} based on the prototype filter p of the second filterbank;
generating a cross-correlation p₂ of the acausal prototype filter p_{A} and the prototype filter p of the second filterbank;
generating a set of matrices V^{(k)}, k=−K, . . . , K for some integer K with dimensions S×R and with non-zero elements v_{n,m} only for indices n, m with n-m being an integer multiple of S, where R is the length of the prototype filter for filter conversion; and solving a set of least-square problems for v (k) q, where q is a vector of dimensions R×1 including the filter coefficients of the prototype filter q for filter conversion.

EEE13. The method according to any one of EEE8 to EEE12, wherein generating the time-domain filter for a given second band further comprises:

taking a weighted sum of the adapted first filters, wherein the adapted first filters are weighted with the prediction coefficients for the respective first bands.

EEE14. The method according to any one of EEE8 to EEE13, wherein the prototype filter for filter conversion is an asymmetric prototype filter.

EEE15. The method according to any one of EEE8 to EEE14, wherein the processing stride for each tap is equal or smaller than the number of second bands.

EEE16. The method according to any one of EEE1 to EEE7, wherein generating the time-domain filter for a given second band comprises:
approximating a given first filter by first and second elementary signals, wherein the first elementary signals are obtainable as results of applying the second filter bank, elementary real-valued single-tap filters, and a synthesis filter bank of the second filter bank to elementary signals with single non-zero samples at respective sample positions, wherein the elementary real-valued single-tap filters are filters for respective single ones of the second bands with single non-zero filter coefficients at respective tap positions; and wherein the second elementary signals are obtainable as results of applying the second filter bank, elementary imaginary single-tap filters, and the synthesis filter bank of the second filter bank to the elementary signals, wherein the elementary imaginary single-tap filters are filters for respective single ones of the second bands with single non-zero filter coefficients at respective tap positions; and
generating adapted time domain filters for the first filters in the second band based on coefficients of first and second elementary signals in the approximation.

EEE17. The method according to any one of EEE1 to EEE7, wherein generating the time-domain filter for a given second band comprises:
obtaining results u_{p,l,k} of applying the second filterbank, real-valued single tap filters F_{λ}^{(re)}(κ)=δ(λ−l, κ−k), and a synthesis filterbank of the second filterbank to signals xₚ(k)=8 (k-p), where l indicates a given second band, p indicates a given sample position, and k indicates a filter tap position;
obtaining results v_{p,l,k} of applying the second filterbank, imaginary single tap filters Fλ^{(im)}(κ)=iδ(λ−l, κ−k), and the synthesis filterbank of the second filterbank to the signals xₚ(k)=δ(k−p);
determining a least-squares solution for coefficients aₗ and bₗ such that

$${\sum }_{l = 0}^{L - 1} {\sum }_{k = 0}^{{N}_{l}} ( {a}_{l} ( k ) {u}_{p , l , k} ( n ) + {b}_{l} ( k ) {v}_{p , l , k} ( n ) ) \approx {h}_{b} ( n - {D}_{3} - p )$$

for a given delay D₃, where h_{b} is the first filter for first band b, L is the number of second bands, and Nₗ is a predefined number of filter taps for second band l; and
generating an adapted first filter HD of the first filter h_{b} in the second band l as Hₗ^{b}=aₗ+ibₗ.

EEE18. The method according to any one of EEE1 to EEE17, further comprising truncating a filter length of the time-domain filters.

EEE19. The method according to EEE18, wherein the filter length of a given time-domain filter after truncation depends on the respective second band of the time domain filter.

EEE20. The method according to EEE18 or EEE19,
wherein generating the time-domain filter for a given second band involves generating a respective elementary time-domain filter in the given second band for each of the first filters, and generating the time-domain filter in the given second band based on the elementary time-domain filters in the given second band and the prediction parameters; and
wherein truncation of a time-domain filter for the given second band is based on threshold values for the filter coefficients of the elementary time-domain filters, with each threshold value corresponding to a respective one among the first filters, wherein the threshold value for the elementary time-domain filters for a given first filter is derived from a maximum magnitude of said elementary time-domain filters in the plurality of second bands.

EEE21. The method according to EEE20, comprising:
determining, for each first band, a maximum magnitude of the corresponding elementary time-domain filters in the plurality of second bands;
for each first band, determining a minimum truncated filter length for the corresponding elementary time-domain filters in the plurality of second bands based on a threshold value derived from said maximum magnitude; and
for each second band, determining the filter length of the time-domain filter in that second band based on the minimum truncated filter lengths of the elementary time-domain filters in that second band.

EEE22. The method according to any one of EEE1 to EEE6, wherein the time-domain filters are single-tap FIR filters.

EEE23. The method according to EEE22, wherein generating the time-domain filter for a given second band comprises:
determining a first band among the plurality of first bands that has a highest energy in that second band; and
generating the time-domain filter based on a linear-phase approximation of the first filter corresponding to the determined first band and the corresponding prediction coefficient for the determined first band.

EEE24. The method according to EEE22, wherein generating the time-domain filter for a given second band comprises:
determining a set of first bands among the plurality of first bands that have a highest energy in that second band; and
generating the time-domain filter based on a weighted sum of linear-phase approximations of the first filters corresponding to the determined set of first bands, wherein weights in the weighted sum depend on the corresponding prediction coefficients for the determined set of first bands and respective normalized magnitudes or energies of the first bands of the determined set of first bands in that second band.

EEE25. A method of generating a representation of a multichannel audio signal, wherein the representation comprises a first channel and metadata relating to a second channel, and wherein the metadata comprises, for each of a plurality of first bands of a first filter bank, a respective prediction parameter for making a prediction for the second channel based on the first channel in that first band, the method comprising:
generating a prediction for the second channel based on first filters of the first filter bank and the prediction parameters, wherein the prediction for the second channel is represented by a time-domain signal; and
generating a residual of the second channel by subtracting the prediction of the second channel from the second channel in the time-domain.

EEE26. The method according to EEE25, wherein the representation of the multichannel audio signal further comprises the residual of the second channel.

EEE27. An apparatus, comprising a processor and a memory coupled to the processor, and storing instructions for the processor, wherein the processor is adapted to carry out the method according to any one of EEE1 to EEE26.

EEE28. A program comprising instructions that, when executed by a processor, cause the processor to carry out the method according to any one of EEE1 to EEE26.

EEE29. A computer-readable storage medium storing the program according 5 to EEE28.

1. A method of processing a representation of a multichannel audio signal, wherein the representation comprises a first channel and metadata relating to a second channel, and wherein the metadata comprises, for each of a plurality of first bands of a first filter bank, a respective prediction parameter for making a prediction for the second channel based on the first channel in that first band, the method comprising:
applying a second filterbank with a plurality of second bands to the first channel to obtain, for each of the second bands, a banded version of the first channel in that second band, wherein the second filter bank is different from the first filter bank;
for each of the second bands, generating a respective time-domain filter based on the prediction parameters and first filters of the first filter bank, the first filters corresponding to the first bands; and
generating a prediction for the second channel based on the banded versions of the first channel and the time-domain filters in the second bands.

2. The method according to claim 1, wherein generating the prediction of the second channel comprises, for each of the second bands:
generating a prediction for the second channel in that second band based on a filtered version of the first channel in that second band, the filtered version of the first channel being obtained by applying the respective time-domain filter in that second band to the banded version of the first channel in that second band.

3. The method according to claim 1, wherein the multichannel audio signal is either an Ambisonics or an audio signal; and wherein the Ambisonics optionally correspond to First Order Ambisonics, FOA, or Higher Order Ambisonics, HOA.

4. The method according to claim 1, wherein the prediction parameters are SPAR parameters, and/or the first filter bank is a SPAR filter bank comprising FIR band filters that uses an MDFT.

5. (canceled)

6. The method according to claim 1, wherein applying the second filter bank comprises applying a QMF filter bank that is complex valued or applying a complex modulated filter bank.

7. (canceled)

8. The method according to claim 1, wherein generating the time-domain filter for a given second band comprises:
generating a plurality of adapted first filters based on respective first filters and a prototype filter for filter conversion.

9. The method according to claim 8, wherein for a given second band l the adapted first filter Hₗ^{b} of a first filter h_{b} for a given first band b is calculated as
$${H}_{l}^{b} = {\sum }_{n} {h}_{b} ( n + kS ) q ( n ) exp ( - i \frac{π}{L} ( l + \frac{1}{2} ) n )$$
where q is the prototype filter for filter conversion, S is the stride of the second filterbank, L is the number of second bands, and summation for n is over the support of the prototype filter q for filter conversion.

10. The method according to claim 9, further comprising:
generating the prototype filter for filter conversion based on a prototype filter of the second filterbank; or
generating the prototype filter for filter conversion based the prototype filter of the second filterbank by solving a least-squares problem.

11. (canceled)

12. The method according to claim 9, wherein generating the prototype filter for filter conversion comprises:
generating an acausal prototype filter p_{A} based on the prototype filter p of the second filterbank;
generating a cross-correlation p₂ of the acausal prototype filter p_{A} and the prototype filter p of the second filterbank;
generating a set of matrices V^{(k)}, k=−K, . . . , K for some integer K with dimensions S×R and with non-zero elements v_{n,m} only for indices n, m with n-m being an integer multiple of S, where R is the length of the prototype filter for filter conversion; and
solving a set of least-square problems for V^{(k)}q, where q is a vector of dimensions R×1 including the filter coefficients of the prototype filter q for filter conversion.

13. The method according to claim 8, wherein generating the time-domain filter for a given second band further comprises:
taking a weighted sum of the adapted first filters, wherein the adapted first filters are weighted with prediction coefficients for the respective first bands;
wherein a prototype filter for filter conversion is optionally an asymmetric prototype filter; and
wherein the processing stride for each tap is optionally either equal or smaller than the number of second bands.

14. (canceled)

15. (canceled)

16. The method according to claim 1, wherein generating the time-domain filter for a given second band comprises:
approximating a given first filter by first and second elementary signals,
wherein the first elementary signals are obtainable as results of applying the second filter bank, elementary real-valued single-tap filters, and a synthesis filter bank of the second filter bank to elementary signals with single non-zero samples at respective sample positions, wherein the elementary real-valued single-tap filters are filters for respective single ones of the second bands with single non-zero filter coefficients at respective tap positions; and
wherein the second elementary signals are obtainable as results of applying the second filter bank, elementary imaginary single-tap filters, and the synthesis filter bank of the second filter bank to the elementary signals, wherein the elementary imaginary single-tap filters are filters for respective single ones of the second bands with single non-zero filter coefficients at respective tap positions; and
generating adapted time domain filters for the first filters in the second band based on coefficients of the first and second elementary signals in the approximation.

17. The method according to claim 16, wherein generating the time-domain filter for a given second band comprises:
obtaining the first elementary signal by applying, the second filter bank with unit pulse input, real-valued single-tap filters, and a synthesis filter bank of the second filter bank to elementary signals;
obtaining a second elementary signal by applying, the second filter bank, imaginary-valued single-tap filters, and the synthesis filter bank of the second filter bank to the elementary signals;
generating coefficients for the time-domain filter based on a least squares solution of for a given delay using the obtained first and second elementary signals; and
wherein obtaining the first elementary signal comprises:
obtaining results u_{p,l,k} of applying the second filterbank, real-valued single tap filters F_{λ}^{(re)}(κ)=δ(λ−l, κ−k), and a synthesis filterbank of the second filterbank to signals xₚ(k)=δ(k−p), where l indicates a given second band, p indicates a given sample position, and k indicates a filter tap position;
obtaining results v_{p,l,k} of applying the second filterbank, imaginary single tap filters F_{λ}^{(im)}(κ)=iδ(λ−l, κ−k), and the synthesis filterbank of the second filterbank to the signals xₚ(k)=δ(k−p);
determining a least-squares solution for coefficients aₗ and bₗ such that
$${\sum }_{l = 0}^{L - 1} {\sum }_{k = 0}^{{N}_{l}} ( {a}_{l} ( k ) {u}_{p , l , k} ( n ) + {b}_{l} ( k ) {v}_{p , l , k} ( n ) ) \approx {h}_{b} ( n - {D}_{3} - p )$$
for a given delay D₃, where h_{b} is the first filter for first band b, L is the number of second bands, and Nₗ is a predefined number of filter taps for second band l; and
generating an adapted first filter Hₗ^{b} of the first filter h_{b} in the second band l as Hₗ^{b}=aₗ+ibₗ.

18. The method according to claim 17, further comprising:
truncating a filter length of the time-domain filters; and
wherein the filter length of a given time-domain filter after truncation depends on the respective second band of the time domain filter.

19. (canceled)

20. The method according to claim 18,
wherein generating the time-domain filter for a given second band involves generating a respective adapted time-domain filter in the given second band for each of the first filters, and generating the time-domain filter in the given second band based on the adapted time-domain filters in the given second band and the prediction parameters; and
wherein truncation of a time-domain filter for the given second band is based on threshold values for the filter coefficients of the adapted time-domain filters, with each threshold value corresponding to a respective one among the first filters, wherein the threshold value for the adapted time-domain filters for a given first filter is derived from a maximum magnitude of said adapted time-domain filters in the plurality of second bands.

21. The method according to claim 20, comprising:
determining, for each first band, a maximum magnitude of the corresponding adapted time-domain filters in the plurality of second bands;
for each first band, determining a minimum truncated filter length for the corresponding adapted time-domain filters in the plurality of second bands based on a threshold value derived from said maximum magnitude; and
for each second band, determining the filter length of the time-domain filter in that second band based on the minimum truncated filter lengths of the adapted time-domain filters in that second band.

22. The method according to claim 1, wherein the time-domain filters are either single-tap FIR filters or multi-tap FIR filters.

23. The method according to claim 22, wherein generating the time-domain filter for a given second band comprises:
determining a first band among the plurality of first bands that has a highest energy in that second band; and
generating the time-domain filter is based on one of:
a linear-phase approximation of the first filter corresponding to the determined first band and a corresponding prediction coefficient for the determined first band; or
a weighted sum of linear-phase approximations of the first filters corresponding to the determined set of first bands, wherein weights in the weighted sum depend on the corresponding prediction coefficients for the determined set of first bands and respective normalized magnitudes or energies of the first bands of the determined set of first bands in that second band.

24. (canceled)

25. A method of generating a representation of a multichannel audio signal, wherein the representation comprises a first channel and metadata relating to a second channel, and wherein the metadata comprises, for each of a plurality of first bands of a first filter bank, a respective prediction parameter for making a prediction for the second channel based on the first channel in that first band, the method comprising:
generating a prediction for the second channel based on first filters of the first filter bank and the prediction parameters, wherein the prediction for the second channel is represented by a time-domain signal; and
generating a residual of the second channel by subtracting the prediction of the second channel from the second channel in the time-domain;
wherein the representation of the multichannel audio signal further comprises the residual of the second channel.

26. (canceled)

27. (canceled)

28. (canceled)

29. A non-transitory computer-readable storage medium storing instructions that, when executed by one or more processors, cause the one or more processors to perform operations of claim 1.

30. A method of processing a representation of a multichannel audio signal, wherein the representation comprises a first channel and metadata relating to a second channel, and wherein the metadata comprises, for each of a plurality of first bands of a first filter bank, a respective parameter for the second channel based on the first channel in that first band, the method comprising:
applying a second filter bank with a plurality of second bands to the first channel to obtain, for each of the plurality of second bands, a banded version of the first channel in the second band, wherein the second filter bank is different from the first filter bank; and
for each of the plurality of second bands, generating a respective time-domain filter based on the respective parameters and a first filter;
wherein generating the time-domain filter for each of the plurality of second bands comprises:
obtaining a first elementary signal by applying, the second filter bank with unit pulse input, real-valued single-tap filters, and a synthesis filter bank of the second filter bank to elementary signals;
obtaining a second elementary signal by applying, the second filter bank, imaginary-valued single-tap filters, and the synthesis filter bank of the second filter bank to the elementary signals; and
generating coefficients for the time-domain filter based on a least squares solution of for a given delay using the obtained first and second elementary signals.
